(19) United States
(12) Patent Application Publication
(10) Pub. No.: US 2015/0372500 A1
(43) Pub. Date: Dec. 24, 2015

(54) SYSTEMS AND METHODS FOR WIRELESS POWER TRANSFER

(71) Applicant: NORTH CAROLINA STATE UNIVERSITY, Raleigh, NC (US)

(72) Inventors: Srdjan Lukic, Raleigh, NC (US); Zeljko Pantic, Logan, UT (US); Kibok Lee, Raleigh, NC (US)

(21) Appl. No.: 14/764,558

(22) PCT Filed: Feb. 12, 2014
(86) PCT No.: PCT/US14/16092

§ 371 Date: Jul. 29, 2015

Related U.S. Application Data
(60) Provisional application No. 61/764,019, filed on Feb. 13, 2013.

(51) Int. Cl. H02J 5/00; H02J 7/02; H02J 17/00

(52) U.S. Cl. CPC H02J 5/005; H02J 17/00; H02J 7/025

(57) ABSTRACT

Disclosed herein are power transfer systems. The power transfer system includes a receiver configured to wirelessly receive power for powering an electronic device, a power source, and at least one transmitter operably coupled to the power source for wirelessly transferring power generated by the power source. When the at least one transmitter is operably coupled to the receiver, the power source and the at least one transmitter operate together in a first mode such that the power source generates power at a first level and the at least one transmitter transfers the generated power to the receiver. When the transmitter is not operably coupled to the receiver, the power source and the at least one transmitter operate together in a second mode such that the power source generates power at a second level lower than the first level or equal to zero and the transmitter does not wirelessly transfer power.

### CROSS REFERENCE TO RELATED APPLICATIONS

This application is a 35 U.S.C. 371 application of PCT International Patent Application Number PCT/US2014/016092, filed Feb. 12, 2014, which claims the benefit of U.S. Provisional Patent Application No. 61/764,019, filed Feb. 13, 2013 and titled SYSTEM AND METHOD FOR IMPROVED WIRELESS POWER TRANSFER, the content of which is hereby incorporated herein by reference in its entirety.

### TECHNICAL FIELD

The present disclosure is directed towards a system and method for wireless power transfer.

### BACKGROUND

Wireless power transfer (WPT) via magnetic coupling is seen as an effective way to transfer power over relatively large air gaps. Numerous applications of the technology have been considered, including charging batteries of portable electronics and electric vehicles. This inductive transfer method usually includes a source and a receiver. However, electromagnetic field emissions in uncoupled portions of the system should be minimized to meet emission and efficiency standards, thus preventing unnecessary power losses. The emissions losses are further exaggerated when the frequency of the power source is not constant.

Accordingly, for at least the aforementioned reasons, there is a need for improved systems and methods for wireless power transfer.

### SUMMARY

This Summary is provided to introduce a selection of concepts in a simplified form that are further described below in the Detailed Description of Illustrative Embodiments. This Summary is not intended to identify key features or essential features of the claimed subject matter, nor is it intended to be used to limit the scope of the claimed subject matter.

Disclosed herein are systems and methods for wireless power transfer. The power transfer system includes a receiver configured to wirelessly receive power for powering an electronic device, a power source, and at least one transmitter operably coupled to the power source for wirelessly transferring power generated by the power source. Wherein when the at least one transmitter is operably coupled to the receiver, the power source and the at least one transmitter operate together in a first mode such that the power source generates power at a first level and the at least one transmitter transfers the generated power to the receiver. Wherein when the at least one transmitter is not operably coupled to the receiver, the power source and the at least one transmitter operate together in a second mode such that the power source generates power at a second level and the transmitter does not wirelessly transfer power.

### BRIEF DESCRIPTION OF THE DRAWINGS

The foregoing summary, as well as the following detailed description of preferred embodiments, is better understood when read in conjunction with the appended drawings. For the purposes of illustration, there is shown in the drawings exemplary embodiments; however, the presently disclosed invention is not limited to the specific methods and instrumentalities disclosed. In the drawings disclosed throughout the detailed description, one or more systems having a power transfer device that efficiently utilizes power transfer from an energy source with minimal waste are provided.

FIG. 1 is a block diagram of a wireless power transfer system according to embodiments of the present subject matter;

FIG. 2 is a circuit diagram showing the source track and the series-parallel compensated LCC receiver;

FIG. 3A is a graph showing that current gain of parallel LC receiver is negative;

FIG. 3B is a graph showing that current gain of using the LCC receiver is a positive value;

FIG. 4A is a graph showing efficiency of an example system as a function of the load resistance, which controls the voltage gain;

FIG. 4B are graphs that show the increase in Qₜₒₜₐₗ as the current gain reduces;

FIG. 5 is a circuit diagram showing the reduction of the switching loss of inverter switches generated by the reactive current of the uncoupled source tracks when multi source tracks are connected to the inverter in parallel;

FIG. 6A is a graph showing the series-compensated source track in a coupled condition with the receiver;

FIG. 6B is a graph showing the series-compensated source track in an uncoupled condition with the receiver;

FIG. 7A-D are graphs showing input current of an inverter and source track coil in both the coupled and uncoupled condition;

FIG. 8A is a circuit diagram of a multi-resonant receiver with an LC filter at the output;

FIG. 8B is a circuit diagram of a multi-resonant receiver with the LC filter and the load replaced with an ideal current source;

FIG. 9 is a circuit diagram of a receiver equivalent circuit, the rectifier, the filter and the load are replaced with equivalent resistances;

FIG. 10A is a graph showing a timing diagram of the voltages for Zone 1 operation with emphasis on zero-voltage crossings of V_{ac}(t);

FIG. 10B is a graph showing a timing diagram of the voltages for Zone 3 operation with emphasis on zero-voltage crossings of V_{ac}(t);

FIG. 11A-C are graphs showing a timing diagram of a Fourier expansion of the current I_{ac} for 11A mI,_{ac}=1/3, 11B mI,_{ac}>1/3 and 11C mI,_{ac}<1/3;

FIG. 12 is a graph showing a zero-crossing angle θ_{z}, and voltage harmonic ratio m_{V,ac} vs current harmonic ratio m_{I,ac};

FIG. 13 is a graph showing a timing diagram of I_{ac,1} and I_{ac,3} for current ratio M_{I,ac}=0.2 (Zone 2);

FIG. 14 is a graph showing a timing diagram of V_{oc,1}, V_{oc,3}, V_{ac,1}, and V_{ac,3} for current ratio m_{I,ac}=0.2 (Zone 2);

FIG. 15 is a graph showing a timing diagram of I_{ac,1} and I_{ac,3} for current ratio M_{I,ac}=1 (Zone 1);

FIG. 16 is a graph showing a timing diagram of V_{oc,1}, V_{oc,3}, V_{ac,1}, and V_{ac,3} for current ratio m_{I,ac}=1 (Zone 1);

FIG. 17 is a graph showing a timing diagram of I_{ac,1} and I_{ac,3} for current ratio M_{I,ac}=−0.5 (Zone 3);

FIG. 18 is a graph showing a timing diagram of V_{oc,1}, V_{oc,3}, V_{ac,1}, and V_{ac,3} for current ratio m_{I,ac}=−0.5 (Zone 3);

FIG. 19 is a graph of simulation and analytical results of normalized equivalent resistances R_{ac,1} and R_{ac,3};

FIG. 20 is a graph of simulation and analytical results of normalized power Pₒᵤₜ/P_{ac,1};

FIG. 21 is a graph of voltage harmonics versus duty ratio D of a phase controlled inverter;

FIG. 22 is a circuit diagram of an exemplary model of the primary (transmitter) of an IPT system;

FIG. 23 is a circuit diagram of an exemplary detailed model of a primary (transmitter) with L-C-L-C compensation circuit in the form of a Cauer 1 ladder network; and

FIG. 24 is a graph of a timing diagram of the transmitter's signals.

### DETAILED DESCRIPTION

While the disclosure of the technology herein is presented with sufficient details to enable one skilled in this art to practice the invention, it is not intended to limit the scope of the disclosed technology. The inventors contemplate that future technologies may facilitate additional embodiments of the presently disclosed subject matter as claimed herein. Moreover, although the term “step” may be used herein to connote different aspects of methods employed, the term should not be interpreted as implying any particular order among or between various steps herein disclosed unless and except when the order of individual steps is explicitly described.

WPT via magnetic coupling is seen as an effective way to transfer power over relatively large air gaps. Numerous applications of the technology for providing power to electronic devices may be implemented via the systems and methods disclosed herein. For example, the systems and methods disclosed herein may be used for, but not limited to, charging batteries of portable electronics and electric vehicles.

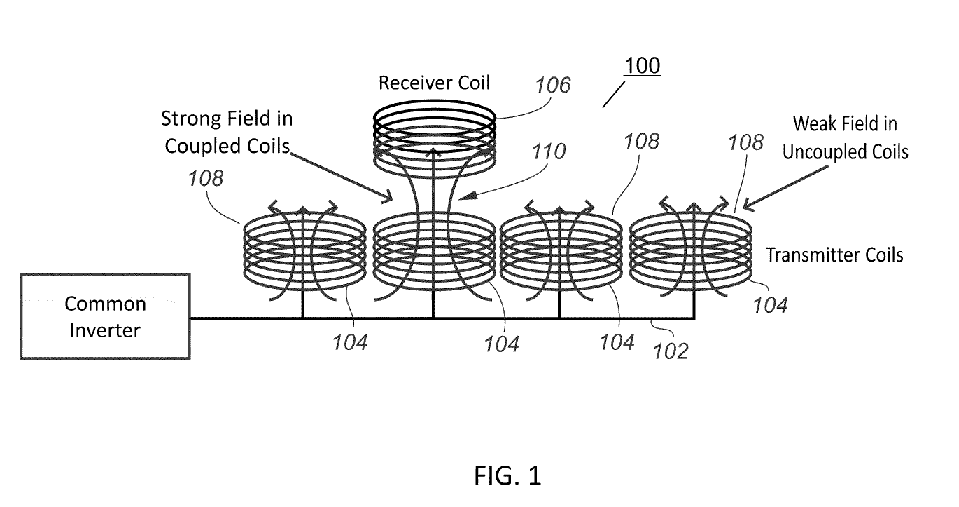

In accordance with embodiments, FIG. 1 illustrates a block diagram of a wireless power transfer system. The system provides sectionalized (referred to as “lumped”) source coils that are commensurable with the receiver to maintain the high coupling coefficient. This approach may be used to solve both the efficiency and the emission challenges in dynamic charging applications. Referring to FIG. 1, a source track 102 includes multiple source track coils (also referred to herein as a “transmitter”) 104 that cover the entirety or a substantial amount of the area where the receiver coil 106 is expected to be placed with each unloaded coil 108 commeasurable with the receiver coil 106. The source track coils 104 can be compensated so that the coil resonance occurs at a frequency offset from the operating frequency of the system 100 in unloaded or uncoupled coils of the source-receiver. The result may be a relatively weak field in the uncoupled coil sections. When the receiver coil 106 is strongly coupled with the source track 102, the magnetic field 110 of the source track may be automatically increased to transfer the power required from the receiver coil 106 as the resonant frequency of source track 102 is brought to the operating frequency through the reflected reactive load from the receiver coil 106. Additional details are provided in the present disclosure.

In wireless power transfer systems, the parallel compensated receiver may be used since it boosts the voltage to the load and it can be easy to decouple with source track by controlling the switch of the receiver driver. The load impedance reflected back onto the source track by the parallel compensated receiver can be described as:

$${Z}_{r} = \frac{{V}_{r}}{{I}_{s}} = \frac{ω {M}^{2}}{{L}_{2}} ( Q - j ) \qquad ( 1 )$$

Typically, the reflected reactance results in higher power supply VA rating, and therefore, increased inverter current, without contributing the real power to the load. This is considered as the disadvantage of the parallel compensated receiver. In order to overcome this disadvantage, the LCL compensated receiver, which reflects purely a real load onto the source track and a unity input power factor may be employed. The system can be configured to have a substantial reactive power reflected onto the source, and to use this property as a way to tune the source circuit.

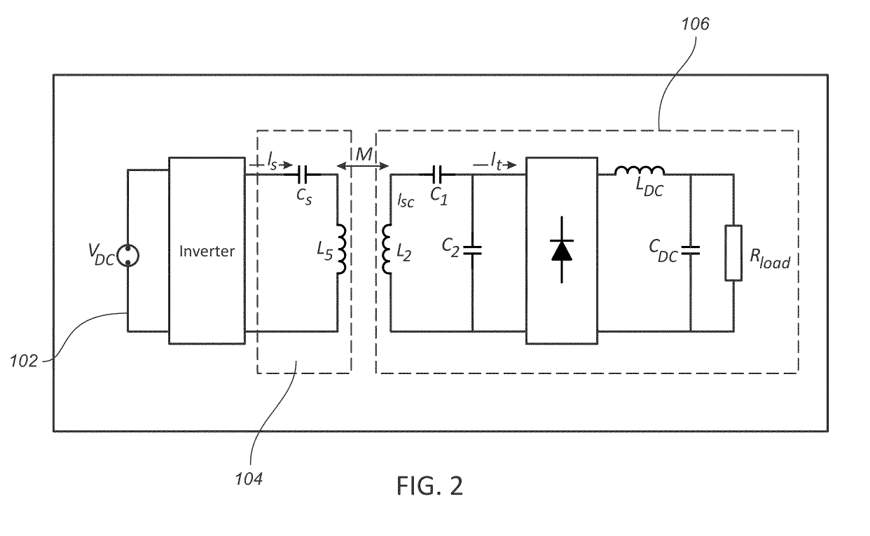

FIG. 2 shows the source track and the series-parallel compensated LCC receiver. The resonant coil of the LCC receiver is series-parallel compensated with capacitors C1 and C2 to form a resonant tank.

The values of two capacitors are chosen for the resonance of receiver to occur at the operating frequency of system as described in (2)-(4):

$$\begin{matrix}{C}_{1} = \frac{n}{n - 1} \cdot C & ( 2 ) \\ {C}_{2} = n \cdot C & ( 3 ) \\ {C}_{1} \vert \vert {C}_{2} = C & ( 4 )\end{matrix}$$

The resonant frequency of the receiver is derived as:

$${ω}_{o} = \frac{1}{\sqrt{{L}_{2} C}} \qquad ( 5 )$$

The quality factor of the system can be calculated by finding the current and voltage boost factor (Q_{I} & Q_{V}). I_{sc} is the short circuit current of the receiver coil and the current boost factor of receiver (Q_{I}) can be defined as:

$${Q}_{I} = \frac{{I}_{t}}{{I}_{SC}} = \frac{{L}_{2}}{{L}_{2} - \frac{1}{{ω}^{2} {C}_{1}}} = \frac{{C}_{2}}{{C}_{1}} + 1 = n \qquad ( 6 )$$

Here Iₜ is the input current of rectifier. The voltage boost factor of receiver (Q_{V}) can be defined as:

$${Q}_{V} = \frac{{V}_{Load}}{{V}_{OC}} = \frac{{R}_{eq}}{ω {L}_{2}} \cdot n = Q \cdot n \qquad ( 7 )$$

V_{Load} is the input voltage of the rectifier, and Q is the quality factor of the parallel compensated receiver. The quality factor (Qₜₒₜₐₗ) of the LCC receiver is obtained by multiplying Q_{I} and Q_{V}:

$${Q}_{total} = {Q}_{I} \cdot {Q}_{V} = \frac{{R}_{eq}}{ω {L}_{2}} \cdot {n}^{2} = Q \cdot {n}^{2} \qquad ( 8 )$$

From (8), the quality factor of the series-parallel compensated LCC receiver depends on the ratio (n) of capacitors used for forming resonant tank, and is different with that of traditional parallel compensated receiver. In addition, the current of the LCC receiver can be defined as:

Iᵢₙ=I_{SC}·n+I_{SC}·Qₜₒₜₐₗ·j (9)

Iₜ=I_{SC}·n (10)

I_{C}_{₂}=I_{SC}·Qₜₒₜₐₗ·j (11)

Here Iᵢₙ is the coil current, Iₜ is the input current of rectifier, I_{C2} is the current of parallel capacitor. R_{Load} can be replaced by the effective load (R_{eq}) seen by resonant tank before the rectifier. The value of R_{eq} is determined by:

$${R}_{eq} = \frac{{π}^{2}}{8} {R}_{Load} \qquad ( 12 )$$

The impedance (Zᵢₙ) of the LCC receiver seen by the open circuit voltage is calculated as:

$${Z}_{in} = jω {L}_{2} + \frac{1}{j ω {C}_{1}} + ( {R}_{eq} \vert \vert \frac{1}{j ω {C}_{2}} ) = \frac{ω {L}_{2}}{n} \frac{{Q}_{V} + j}{1 + {Q}_{V}^{2}} \qquad ( 13 )$$

The load impedance reflected back onto the source track by the LCC receiver can be defined by:

$${Z}_{r} = \frac{{( ω M )}^{2}}{{Z}_{in}} = \frac{ω {M}^{2}}{{L}_{2}} ( {Q}_{total} - n \cdot j ) \qquad ( 14 )$$

It is noticed that if n is chosen to be greater than one, the amount of reflected reactive load from the LCC receiver can be larger than that of the parallel compensated receiver obtained in (1). It means that the LCC receiver can shift the resonant frequency of the source track more than the parallel compensated receiver can. In FIG. 2, the source track coil 104 is compensated with Cₛ as considering the reactive load reflected from the receiver.

$${Z}_{S} = j ω {L}_{S} + \frac{1}{j ω {C}_{S}} = \frac{ω {M}^{2}}{{L}_{2}} n \cdot j = Δ X ( ∵ j ω {L}_{S} + \frac{1}{j ω {C}_{S}} - Δ X = 0 ) \qquad ( 15 )$$

Here, ΔX is the amount of reactive load which may be reflected from the LCC receiver in the coupled condition. When the source track is coupled with the LCC receiver, the impedance of the source track is obtained as:

$${Z}_{S} = j ω {L}_{S} + \frac{1}{j ω {C}_{S}} + {Z}_{r} = \frac{ω {M}^{2}}{{L}_{2}} {Q}_{total} = {R}_{r} \qquad ( 16 )$$

Here Rᵣ is the real load reflected from the receiver. This is because all reactive components are cancelled out by the reflected reactive load at the operating frequency. The reflected load from both the LCC receiver and parallel compensated receiver is summarized in Table 1.

TABLE I
THE LOAD REFLECTED TO THE SOURCE

| | Real load | Reactive load |
|---|---|---|
| LC Receiver | $\frac{ω {M}^{2}}{{L}_{2}} Q$ | $- \frac{ω {M}^{2}}{{L}_{2}} j$ |
| LCC Receiver | $\frac{ω {M}^{2}}{{L}_{2}} {Q}_{total}$ | $- \frac{ω {M}^{2}}{{L}_{2}} n \cdot j$ |

The current gain of the source track in case of using the parallel LC receiver is calculated as:

$$Gain [ dB ] = 20 {log}_{10} \frac{\vert {I}_{receiver} \vert}{\vert {I}_{no receiver} \vert} = 20 {log}_{10} \frac{1}{Q} \qquad ( 17 )$$

The current gain is always a negative value since a quality factor in wireless power transfer systems is chosen to be greater than one. In contrast, the current gain of the LCC receiver can be a positive value if the ratio (n) of series and parallel capacitors is chosen to be larger than the quality factor. The current gain of the source track in case of using the LCC receiver is described as:

$$Gain [ dB ] = 20 {log}_{10} \frac{n}{{Q}_{total}} \qquad ( 18 )$$

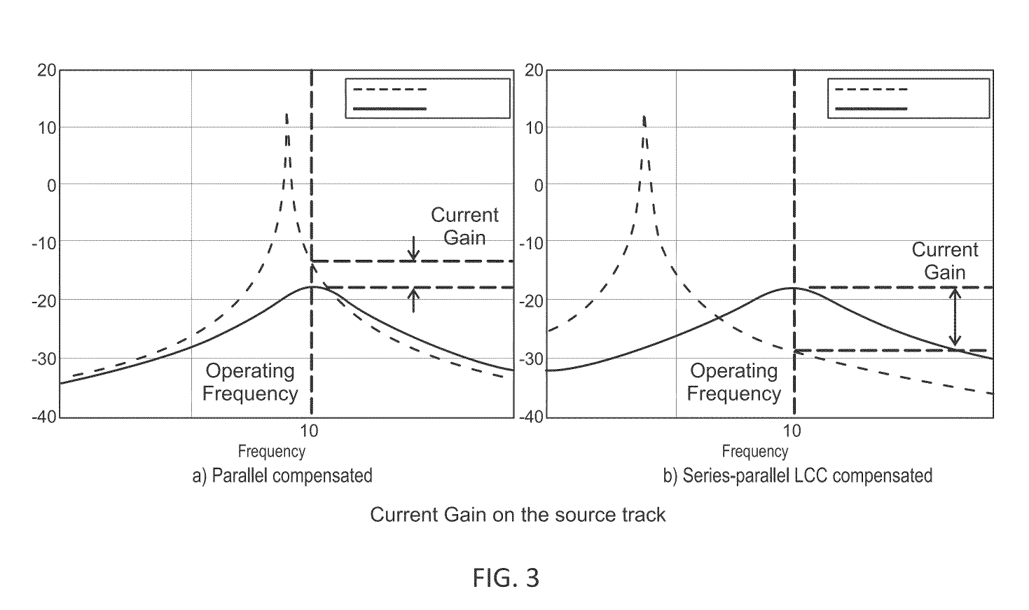

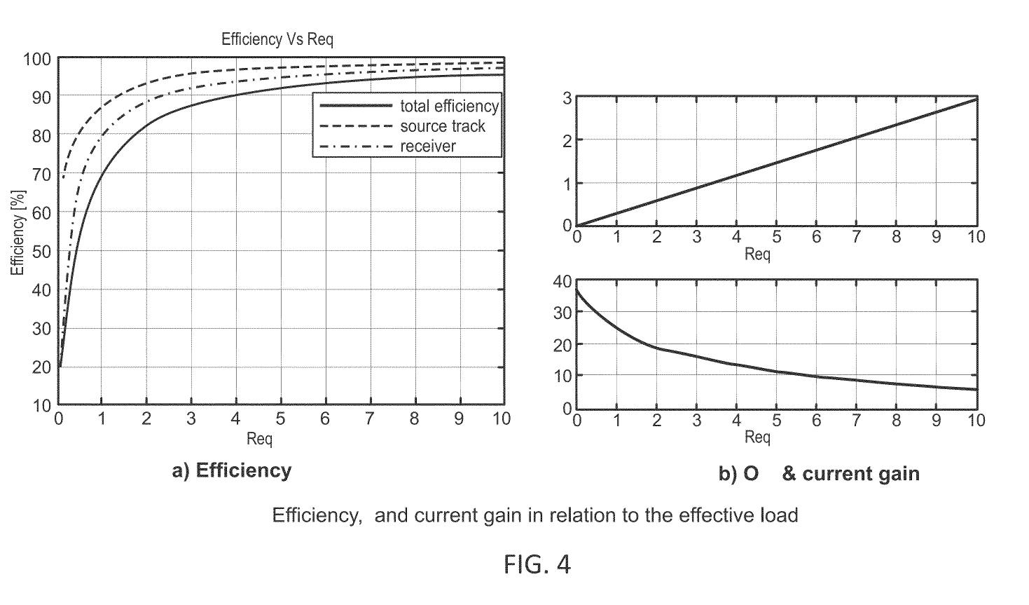

As shown in FIG. 3A, the current gain of parallel LC receiver is a negative value. In contrast, FIG. 3B shows that the current gain in case of using the LCC receiver is a positive value. As a result, the electromagnetic field emission can be limited since the current flowing in the source track is reduced in the uncoupled condition. However, the ratio (n) cannot be increased up to very high value because the efficiency of the receiver decreases due to the increase of a circulating current by the ratio (n). Therefore, all parameters of circuit should be chosen to maximize the current gain of source track while the system satisfies the expected overall efficiency. FIG. 4A shows the efficiency of the proposed system as a function of the load resistance (which controls the voltage gain). It may be concluded that a larger voltage gain would be beneficial. On the other hand, as shown in FIG. 4B it is apparent that with the increase in Qₜₒₜₐₗ the current gain reduces, making the difference in current between the coupled and uncoupled sections ever smaller for higher quality factors. Therefore, a tradeoff between efficiency and current gain may be needed.

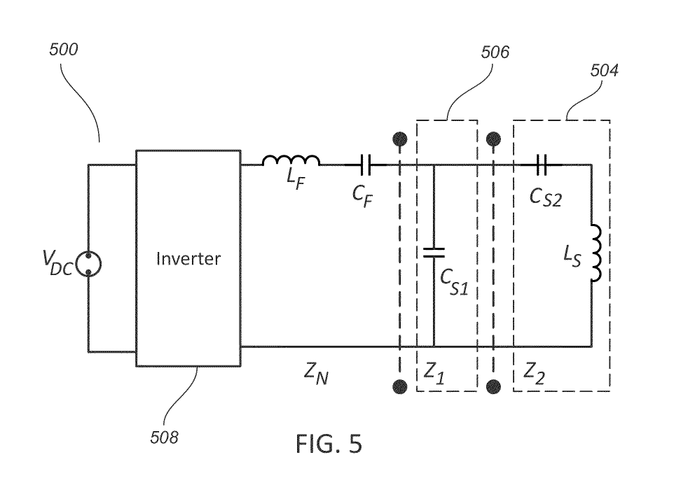

The source track 500 can reduce the switching loss of inverter switches generated by the reactive current of the uncoupled source tracks when multi source tracks are connected to the inverter in parallel. The configuration of the source track 500 is shown in FIG. 5.

The basic principle is to make the input impedance (Zᵢₙ) 502 to be very high in the uncoupled condition with the receiver 106. A LC series filter 504 and parallel capacitor 506 are added to the series compensated source track 500. This resulting impedance is:

$${Z}_{1} = \frac{( j ω {L}_{s} + \frac{1}{jω {C}_{{s}_{2}}} ) \cdot \frac{1}{j ω {C}_{{s}_{1}}}}{j ω {L}_{S} + \frac{1}{j ω {C}_{{s}_{1}}} + \frac{1}{j ω {C}_{{s}_{2}}} } \qquad ( 19 )$$

The value of Cs₁ is chosen to make the denominator of impedance (Z₁) to be zero at the operating frequency. Then, the impedance seen by the inverter 508 becomes very high. An additional bandpass LC filter (formed by L_{F} and C_{F}) is added to eliminate the high order harmonics. Therefore, the inverter current may be almost zero. When the source track 500 is coupled with the receiver, the impedance (Z₂) may be changed as a pure real load by the reflected load from the receiver. At this condition, the impedance (Z₁) is defined as:

$${Z}_{1} = \frac{{R}_{r}}{1 + {( ω {C}_{{s}_{1}} {R}_{r} )}^{2}} - \frac{ω {C}_{{s}_{1}} {R}_{r}}{1 + {( ω {C}_{{s}_{1}} {R}_{r} )}^{2}} j ≃ {R}_{r} - ω {C}_{{s}_{1}} {R}_{r} j \qquad ( 20 )$$

Here, Rᵣ is the reflected real load from the receiver. In (20), the impedance has a little capacitance component. This can be removed as making the LC series filter to have a sufficiently small inductance component at the operating frequency. As a result, the coil current as well as the inverter current can be automatically controlled by using the source track 500 because the impedance (Z₁, Z₂) is changed as the coupling condition.

As an example, the parameters are selected as listed in Table II. The operating frequency of the source power supply is 100 kHz. The experiment was implemented at the output power of 300 W. To validate the effect of using the series-parallel LCC receiver, the coil current of the source track was measured under both the uncoupled and coupled condition with the receiver.

TABLE II
THE SYSTEM PARAMETERS

| | Parameter | Value | |
|---|---|---|---|
| Source track | L [symbol] | 191 | uH |
| | C [symbol] | 19.32 | nF |
| Receiver | L₀ | 191 | uH |
| | C₁ | 15.97 | nF |
| | C₂ | 78.25 | nF |

| n | 5.9 | |
|---|---|---|
| R [symbol] | 4.2 | Ω |

[symbol]

indicates data missing or illegible when filed

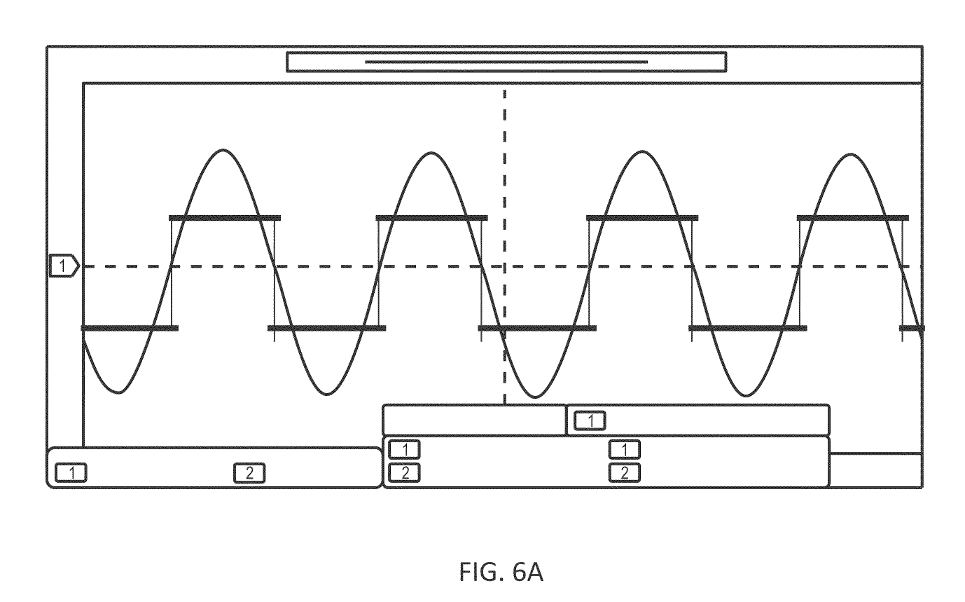

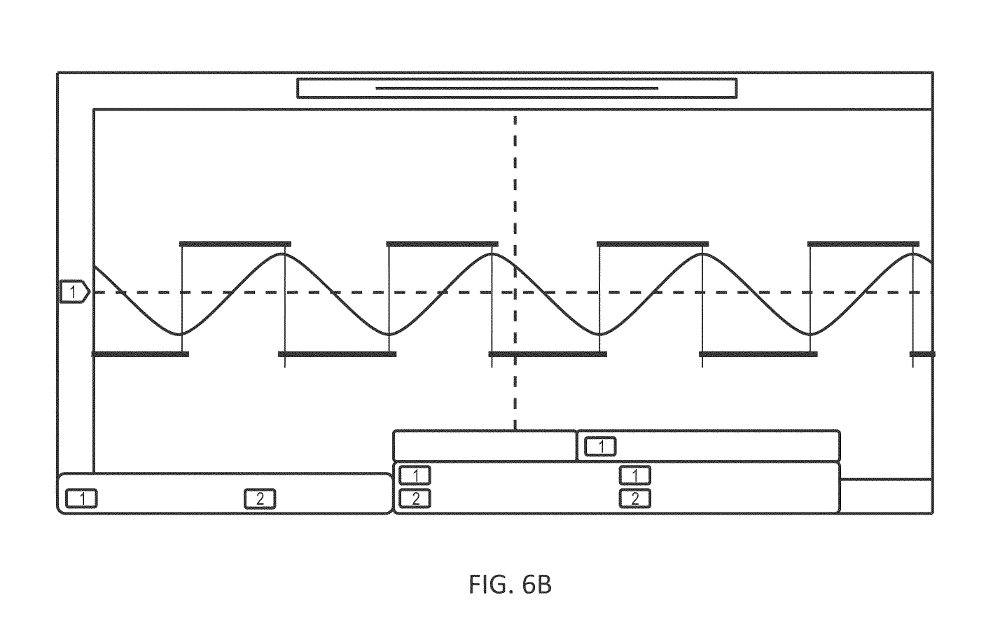

As an example, FIG. 6 shows the current and voltage of the series-compensated source track at the load resistor (4.2Ω). FIG. 6A shows the series-compensated source track in a coupled condition with the receiver. FIG. 6B shows the series-compensated source track in an uncoupled condition with the receiver. The current in the coupled condition is 9.25 A, and the current in the uncoupled condition is 2.82 A. The current gain of the source track coil is 10.32 dB at the coupling factor (k=0.224). The quality factor of the receiver is 1.50. The overall efficiency of system is 82.03%. When the load is changed to 6.24Ω, the current in the coupled condition is 6.62 A, and the current in the uncoupled condition is 2.72 A. The current gain of the source track coil is 7.73 dB at the same coupling factor. The quality factor is 2.23. The efficiency of system is 84.77%. This means that the efficiency can be improved as increasing the quality factor, even though the current gain is decreased, in this example.

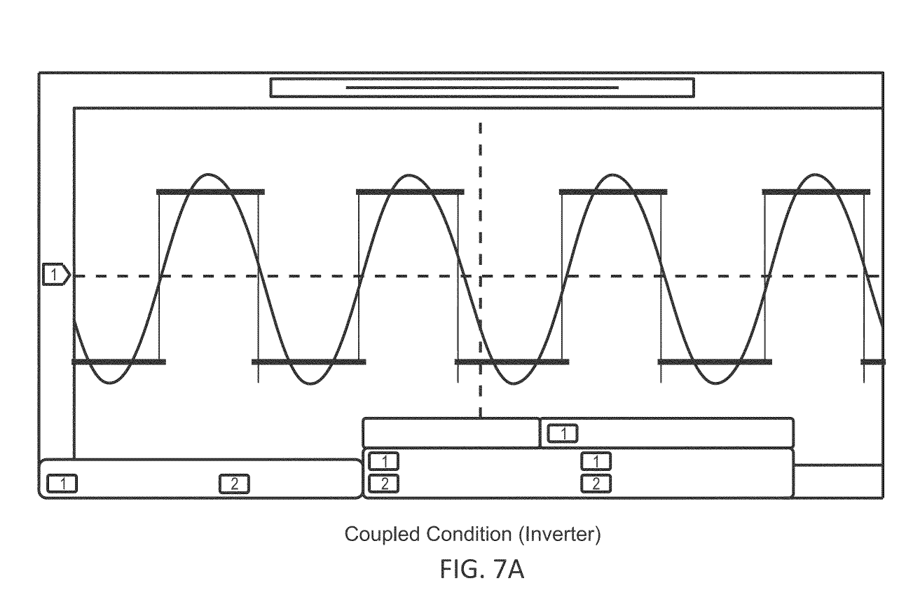

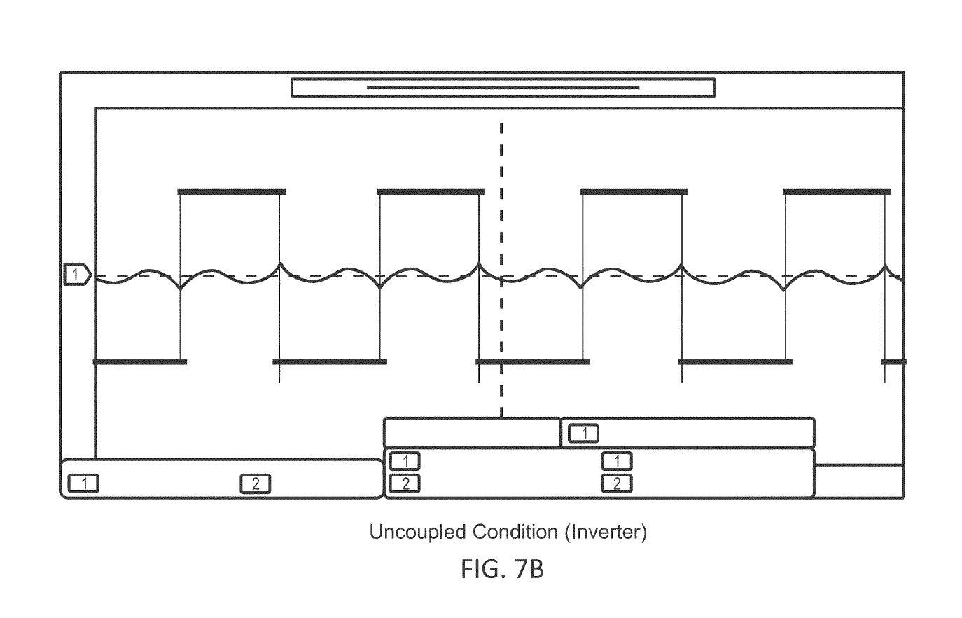

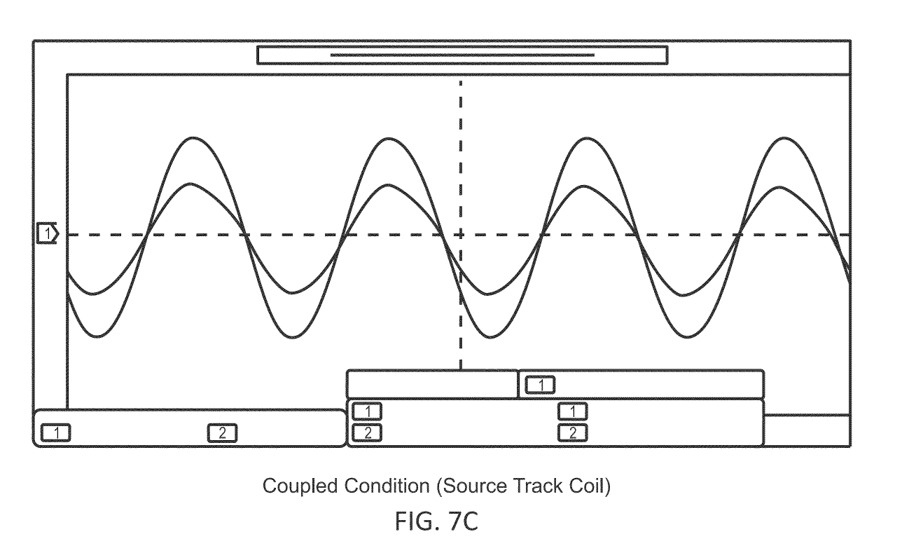

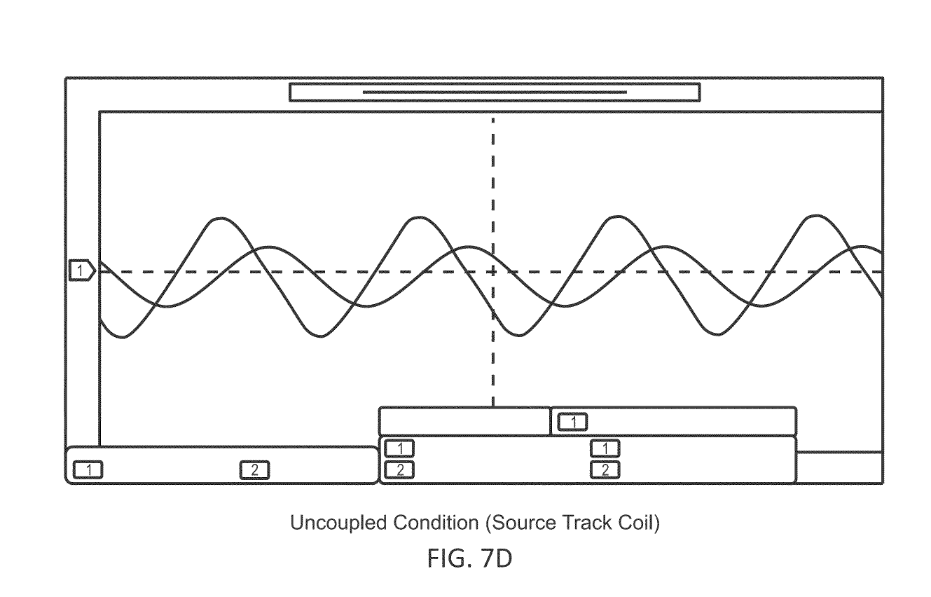

FIGS. 7A-D shows the exemplary input current of inverter and source track coil in case of using the new proposed source track. In the uncoupled condition, the inverter current is reduced up to 511 mA. The current gain of source track coil is 10.46 dB. The efficiency of system is 80.45%. It is decreased a little compared to the sense compensated source track because of additional capacitors and inductor.

The WPT system has been designed by using a series compensated source track and a series-parallel compensated LCC receiver. The advantage of using the LCC receiver has been described and compared to parallel compensated receiver in terms of reflected load to the source track. In addition, the source track is developed to reduce the switching loss of the inverter switches generated by the reactive current of the uncoupled source tracks when multi source tracks are connected to the inverter.

Selection of an optimal signal frequency is one of the most complex problems in the design of a system for wireless power transfer. Indeed, regarding the same previous derivation and expressions, a higher frequency leads to a better design with a higher power transfer. Although it is true in terms of transferred power, the situation changes when the second order effects are taken into consideration, since the overall efficiency reduces. A part of the problem lays in the fact that the power converters that would process high power at very high frequency are not readily available. If they exist, they typically results in either low efficiency or complicated and unreliable design. The direct impact of the higher switching frequency is the increase of switching losses at the primary (transmitter) side, and even so to some extent at the receiver side, if the power is rectified and delivered to the load in a controllable manner. It may be beneficial to somehow detach the coupling that exist between the switching frequency of the power converter and the frequency of the magnetic field, with the former kept as low as possible for selected signal frequency.

Another problem may be the lack of signal multiplex when the power is transferred wirelessly. While this approach is almost necessity when the communication signals are distributed both by wire or wirelessly, there was no design that have applied that for wireless power transfer. Indeed, all available designs tried to filter out any input signal of “unwanted” frequency and augment the targeted one for the power transfer.

As described herein, this WPT system solves both the problems described above. The system is able to preserve a low switching frequency by engaging the switching harmonics in the power transfer as well, the same ones that have been filtered out as described herein. The wireless power multiplex is allowed by redesigning the resonant circuits at both the primary and secondary to resonate at more than one frequency. The multi-resonant topologies reported applications only included the design of multi-resonant analog filter inductors integrated on printed boards or the systems for energy transfer between two reactive elements. According to our best knowledge, the multi-resonant topologies have not been applied for the wireless power transfer so far. The part of the explanation for the deficit is that the rectifier system at the receiver side makes the whole system nonlinear which introduces some difficulties in the design procedure. This particularly issue is described herein with a solution for the system that exploits the first and the third harmonic is demonstrated.

A thorough analysis of the multi-resonant system is provided. Besides the analytical description, Simulink-based numerical simulations are included to prove the proposed design procedure. As described herein, a design of a multi resonance receiver is explained. The reader should note the derivation of the expressions of equivalent resistances that corresponds to two harmonics applied for the power transfer, and which can be used to replace the nonlinear rectifier at the output. That way the circuit is linearized and the well-established Laplace's concept can be used for the resonant circuit design. Additionally, a ladder LC Cauer 1 topology of the compensation circuit is used and formulas for inductance and capacitance values are derived, as functions of the load characteristics and open-circuit voltages. As an example, this particular topology has been selected due to very low sensitivity to non-exact value of its components, which is a feature for the IPT designs.

A similar ladder LC Cauer 1 topology is used at the primary side, and its design is described herein. In this description, the goal was to design a load independent track current, but this time that resonates at two or more resonant frequencies (signal harmonics).

As described herein, a framework of a multi-resonance receiver design may be given. The analysis that follows primarily treats the receivers resonating at two signal harmonics, but the analysis can also be generalized for more than two. Although the main objective is to select a topology and derive formulas for resonant circuit design, the central part of this section is derivation of equivalent resistances R_{ac,1} and R_{ac,3} that allow apparent linearization of the receiver circuit and application of the Laplace transform.

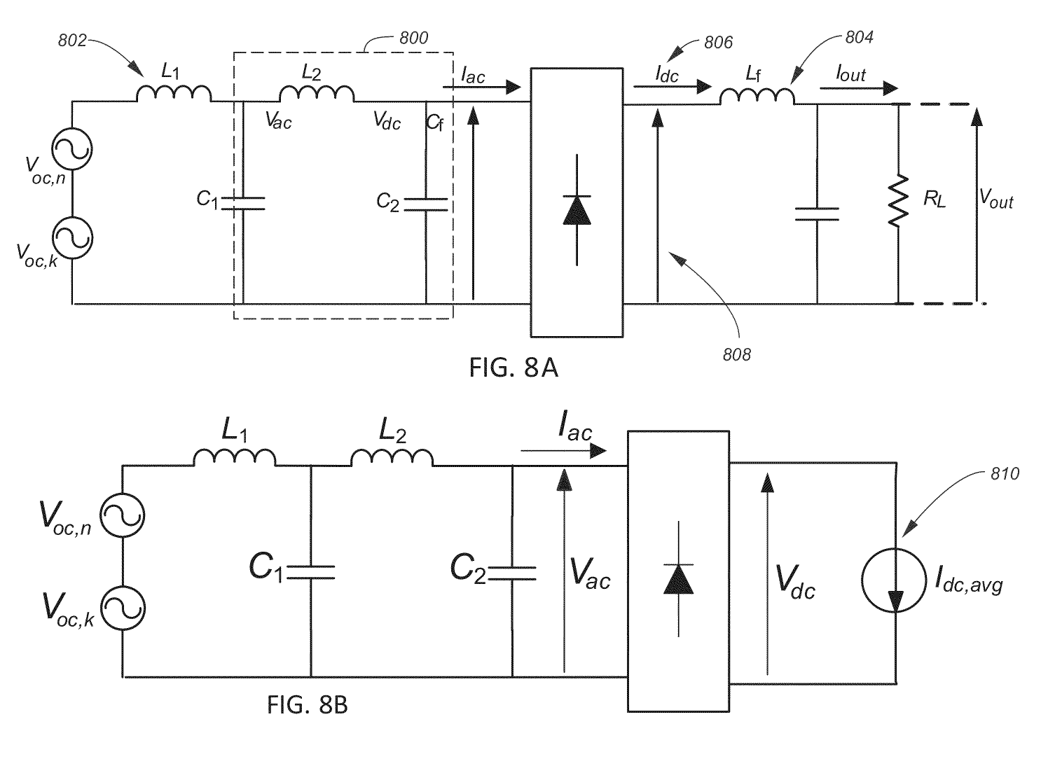

To focus our attention to other important aspects of the resonant tank designing procedure, the output power conditioner may be replaced with a simple LC filter. Inclusion of a boost or some other converter between the rectifier and the load would only simplify the design since it would allow an arbitrary equivalent resistance R_{dc} for specified output power and voltage conditions, which would not be the case for an LC filter applied. A parallel compensation tank C₁-L₂-C₂ 800 in a it configuration has been chosen, as it is shown in FIG. 8A. Combined with the self-inductance of the receiving coil L₁ 802, the resonant circuit creates an L-C-L-C ladder configuration.

Assuming that the cut-off frequency of the LC filter is sufficiently small enough compared to the signal frequency, and accepting large value of the filter inductance L_{f} 804, the harmonics in the I_{dc} 806 can be neglected and the average value of V_{dc} 808 voltage would be approximately equal to the output voltage:

I_{dc}≈I_{dc,avg}=Iₒᵤₜ, (21)

V_{dc,avg}=Vₒᵤₜ, (22)

Consequently, the filter and the load can be replaced with an ideal current source 810, as it is exemplified in 8B:

$${I}_{dc} = \frac{{V}_{out}}{{R}_{L}} . \qquad ( 23 )$$

The circuit may be further simplified by replacing the rectifier and current source such that the circuit would properly model the power transfer from the ac to the dc side of the system. Although it was an easy task for single-frequency systems (resulting in πn²/8*R_{dc} equivalent resistance), it is much more difficult if more than one frequency are present at the input of the rectifier. One of the difficulties may be the calculation of the dc value of the rectified voltage as a function of two ac signal at the input of the bridge. Indeed, the rectified voltage may depend on both the amplitude ratio and phases of the two harmonics present at the input of the rectifier:

V_{ac}(t)=V_{ac,n}(t)V_{ac,k}(t)⁻

V_{ac,n}(t)=V_{ac,n,m} sin(nω₁)

V_{ac,k}(t)=V_{ac,k,m} sin(kω₁+θₖ) (24)

where the phase of harmonic n is selected to be zero (θₙ=0) without losing the generality of the approach, and n and k are two odd numbers (n<k). As may be explained later, cases when these two signals are in phase or anti phase (θₖ=0 or θₖ=π) may be particularly interesting. By introducing the parameter m_{V,ac} as the ratio of the ac voltage harmonics at the input of the rectifier, the expression for V_{ac} can be written as:

$$\begin{matrix}{m}_{V , ac} = \pm \frac{{V}_{ac , k}}{{V}_{ac , n}} , & ( 25 ) \\ {V}_{ac} ( t ) = {V}_{ac , n , m} ( sin ( n {ω}_{1} t ) + {m}_{V , ac} sin ( k {ω}_{1} t ) ) . & ( 26 )\end{matrix}$$

The positive sign in (25) corresponds to in-phase harmonics V_{ac,n} and V_{ac,k}, where the negative sign describes the anti-phase case. These two cases are analyzed below for the specific situation where the first and the third harmonics are applied, and the values for the equivalent ac resistances R_{ac,1} and R_{ac,3} has been derived there as the function of parameter m_{V,ac} and the load resistances R_{L}. Assuming that value for R_{ac,p} is known, the circuit can be simplified even more, as it is shown in 9. As one can see, R_{ac} 900 might be different for different harmonics, which is denoted in by using p in the subscript.

The voltage signal at the input of the diode rectifier consists of the first and the third harmonics:

V_{ac}(t)=\sqrt{2}V_{ac,1}(sin(ω₁t)+m_{V,ac} sin (3ω₁t)). (27)

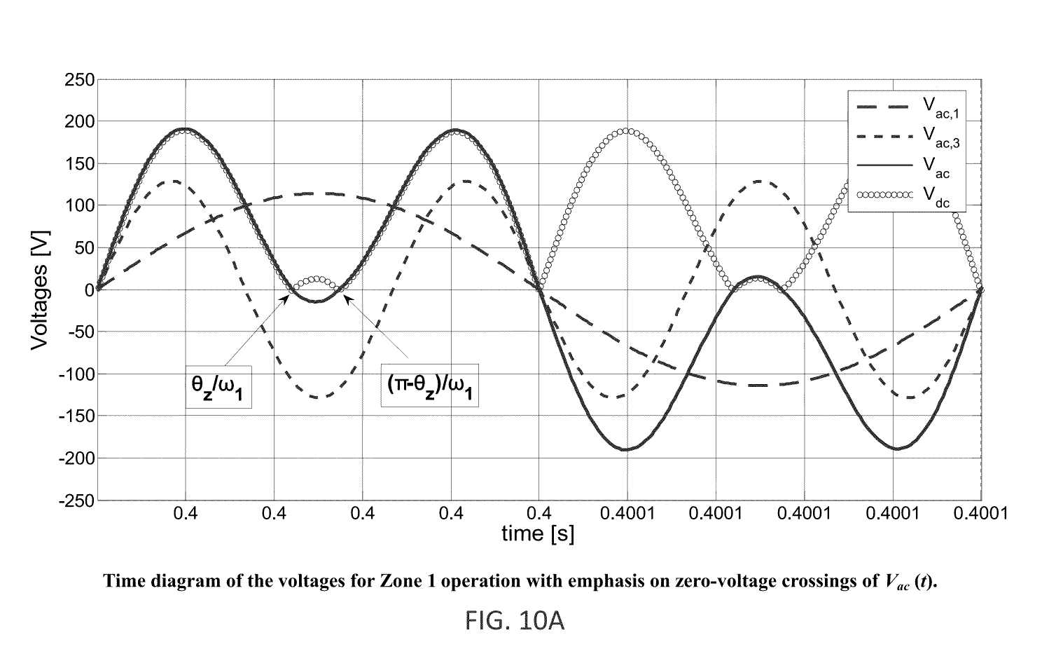

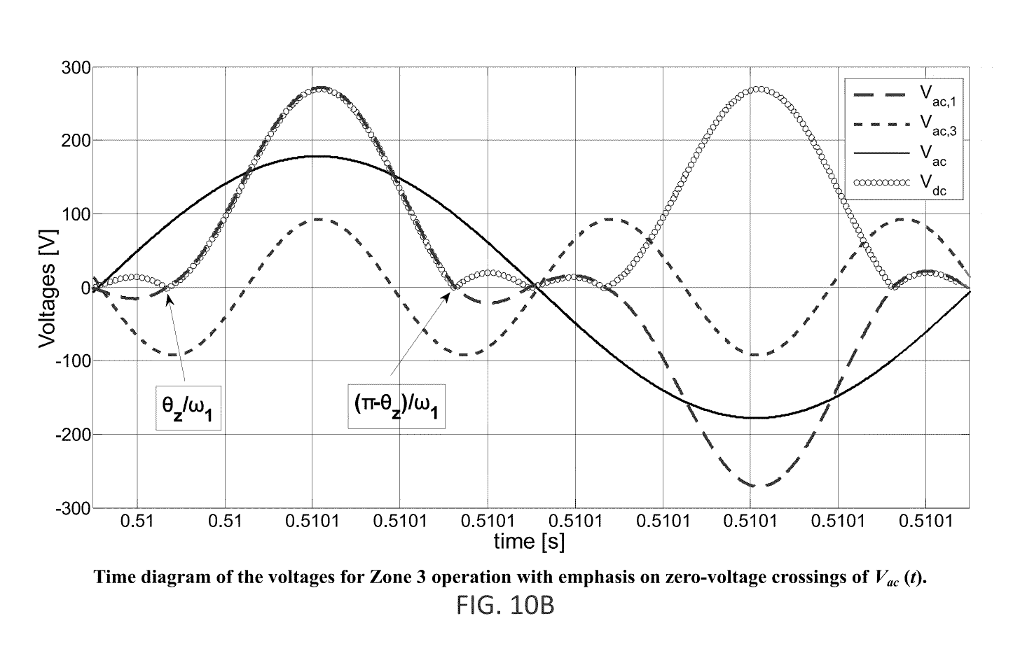

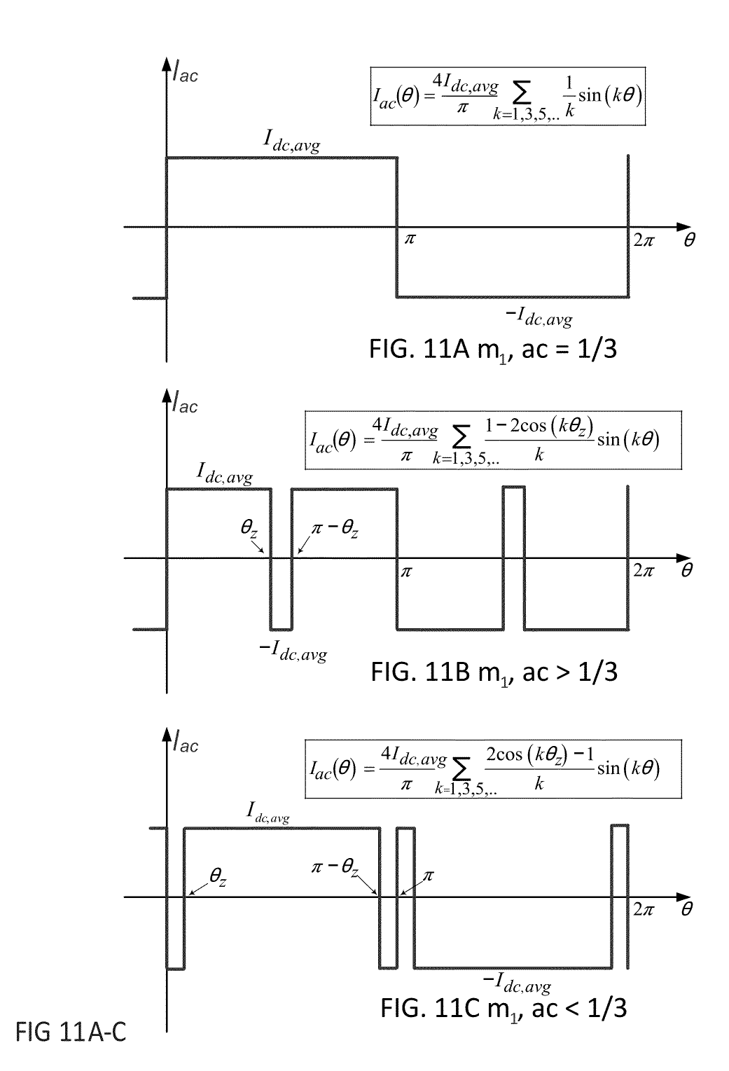

The voltage ratios of interest belong to the Zone 1 where m_{V,ac}≧1 (m_{I,ac}≧1/3), and Zone 3, where m_{V,ac}<−0.395 (m_{I,ac}≦0). In both cases, voltage V_{ac}(t) may have total of 6 zero-crossings in one period, as it was demonstrated in 10A for Zone 1, and FIG. 10B for Zone 3. In simulated examples that have generated the described figures, 1V-diode voltage drop is introduced to allow simultaneous visualization of both V_{ac}(t) and rectified V_{ac}(t). For the rectified voltage:

V_{dc}(t)=|V_{ac}(t)|\sqrt{2}V_{ac,1}=|(sin(ω₁t)+m_{V,ac} sin(3ω₁t))|, (28)

it is not difficult to derive the average value over a period by exploiting the symmetry of the V_{ac}(t):

$$\begin{matrix}{V}_{dc , avg} ( {m}_{V , ac} \geq 1 ) = \frac{2}{π} {\int }_{0}^{\frac{π}{2}} \vert {V}_{ac} ( θ ) \vert d θ == \frac{2 \sqrt{2}}{π} {V}_{ac , 1} ( {\int }_{0}^{{θ}_{z}} ( sin θ + {m}_{V , ac} sin ( 3 θ ) ) d θ - {\int }_{{θ}_{z}}^{\frac{π}{2}} ( sin θ + {m}_{V , ac} sin ( 3 θ ) ) d θ ) & ( 29 ) \\ {V}_{dc , avg} ( {m}_{V , ac} \leq - 0.395 ) = \frac{2}{π} {\int }_{0}^{\frac{π}{2}} \vert {V}_{ac} ( θ ) \vert d θ == \frac{2 \sqrt{2}}{π} {V}_{ac , 1} ( {\int }_{0}^{{θ}_{z}} ( sin θ + {m}_{V , ac} sin ( 3 θ ) ) d θ - {\int }_{{θ}_{z}}^{\frac{π}{2}} ( sin θ + {m}_{V , ac} sin ( 3 θ ) ) d θ ) & ( 30 )\end{matrix}$$

The final expressions for both cases can be written as:

$${V}_{dc , avg} = \pm \frac{2 \sqrt{2}}{π} {V}_{ac , 1} ( ( 1 + \frac{{m}_{V , ac}}{3} ) + 2 \frac{{m}_{V , ac} - 1}{3} \sqrt{\frac{{m}_{V , ac} - 1}{{m}_{V , ac}}} ) , \qquad ( 31 )$$

where “+” sign belongs to the Zone 1 solution, while the solution for the Zone 3 includes the sign “−” in front of the expression.

At the dc side, the output power can be expressed as a function of an equivalent dc resistance R_{dc} which is equal to the load resistance R_{L} if an ideal LC filter is applied:

$${P}_{dc} = \frac{{V}_{dc , avg}^{2}}{{R}_{dc}} = \frac{{V}_{dc , avg}^{2}}{{R}_{L}} . \qquad ( 32 )$$

At the ac side, R_{ac,1} and R_{ac,3} may be used to model the individual contribution of each harmonic to power transferred to the load:

$${P}_{ac} = \frac{{V}_{ac , 1}^{2}}{{R}_{ac , 1}} + \frac{{V}_{ac , 3}^{2}}{{R}_{ac , 3}} , \qquad ( 33 )$$

Since the R_{ac,1} and R_{ac,3} are not independent:

$${R}_{ac , 3} = \frac{{V}_{ac , 3}}{{I}_{ac , 3}} = \frac{{m}_{V , ac} {V}_{ac , 1}}{{m}_{I , ac} {I}_{ac , 1}} = \frac{{m}_{V , ac}}{{m}_{I , ac}} {R}_{ac , 1} , \qquad ( 34 )$$

the total ac power P_{ac} can be expressed in terms of power delivered at the first harmonic P_{ac,1} and voltage and current ratios:

$${P}_{ac} = \frac{{V}_{ac , 1}^{2}}{{R}_{ac , 1}} + \frac{{( {m}_{V , ac} {V}_{ac , 1} )}^{2}}{\frac{{m}_{V , ac}}{{m}_{I , ac}} {R}_{ac , 1}} = \frac{{V}_{ac , 1}^{2}}{{R}_{ac , 1}} ( 1 + {m}_{V , ac} {m}_{I , ac} ) = {P}_{ac , 1} ( 1 + {m}_{V , ac} {m}_{I , ac} ) . \qquad ( 35 )$$

After neglecting the losses in the bridge, the ac and dc powers may be the same. It allows a relation to be established between the equivalent ac and equivalent dc resistances:

$${P}_{ac} = {P}_{dc} ⇒ {R}_{ac , 1} = {R}_{L} \frac{{V}_{ac , 1}^{2}}{{V}_{dc , avg}^{2}} ( 1 + {m}_{V , ac} {m}_{I , ac} ) . \qquad ( 36 )$$

Combination of (31), (34), and (35) may result in wanted expressions for equivalent ac resistances:

$$\begin{matrix} {R}_{ac , 1} = \frac{{π}^{2}}{8} {R}_{dc} \frac{( 1 + {m}_{I , ac} {m}_{V , ac} )}{{( 1 + \frac{{m}_{V , ac}}{3} + 2 \frac{{m}_{V , ac} - 1}{3} \sqrt{\frac{{m}_{V , ac} - 1}{{m}_{V , ac}}} )}^{2}} , & ( 37 ) \\ {R}_{ac , 3} = \frac{{m}_{V , ac}}{{m}_{I , ac}} {R}_{ac , 1} = \frac{{π}^{2}}{8} {R}_{dc} \frac{{m}_{V , ac}}{{m}_{I , ac}} \frac{( 1 + {m}_{I , ac} {m}_{V , ac} )}{{( 1 + \frac{{m}_{V , ac}}{3} + 2 \frac{{m}_{V , ac} - 1}{3} \sqrt{\frac{{m}_{V , ac} - 1}{{m}_{V , ac}}} )}^{2}} . & ( 38 )\end{matrix}$$

Since V_{dc,avg} appears in (36) as a squared variable, the effect of its sign is canceled so the expressions for both Zone 1 and Zone 3 parameters may be identical.

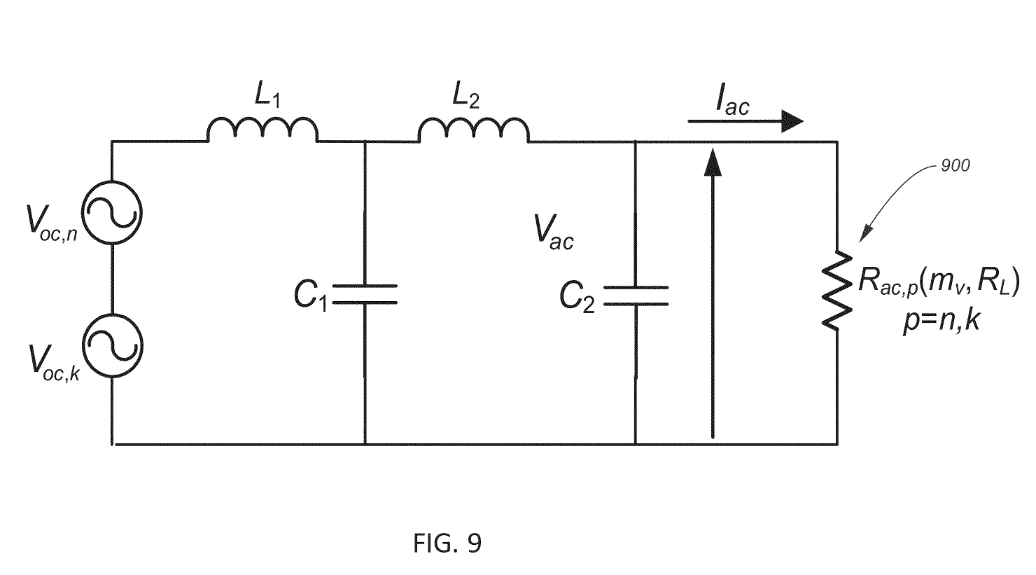

Although this replacement does not make the circuit linear (do not forget that the equivalent resistance R_{ac,p} is now frequency dependent), it allows Laplace operator s to be used to formalize the circuit description at particular frequency. Since the resonant tank behaves as a current source and supplies current to the bridge, transconductance G(s) may be selected as the most appropriate function to describe the characteristics of the tank. With continued reference to FIGS. 9 and 10A-B, it can be written as a function of operator s and circuit parameters:

$$G ( s ) = \frac{{I}_{ac} ( s )}{{V}_{oc} ( s )} = \frac{\frac{1}{{R}_{ac , p} ( {m}_{V ,} {R}_{L} )}}{{L}_{1} {L}_{2} {C}_{1} {C}_{2} {s}^{4} + \frac{{L}_{1} {L}_{2} {C}_{1}}{{R}_{ac , p} ( {m}_{v} , {R}_{L} )} {s}^{3} + ( {L}_{1} {C}_{2} + {L}_{1} {C}_{1} + {L}_{2} {C}_{2} ) {s}^{2} + \frac{{L}_{1} + {L}_{2}}{{R}_{ac , p} ( {m}_{V} , {R}_{L} )} s + 1} . \qquad ( 39 )$$

For an unloaded system (R_{ac,p}→∞), the voltage V_{ac}=R_{ac,p}I_{ac} may resonate at harmonics nω₁ and kω₁ if the four imaginary poles of the voltage gain:

$$\frac{{V}_{ac}}{{V}_{oc}} ( s , {R}_{ac , p} \to ∞ ) = \frac{\frac{1}{{L}_{1} {L}_{2} {C}_{1} {C}_{2}}}{{s}^{4} + \frac{{L}_{1} {C}_{2} + {L}_{1} {C}_{1} + {L}_{2} {C}_{2}}{{L}_{1} {L}_{2} {C}_{1} {C}_{2}} {s}^{2} + \frac{1}{{L}_{1} {L}_{2} {C}_{1} {C}_{2}}} \qquad ( 40 )$$

correspond to ±j(nω₁) and ±j(kω₁). It may be true if the following conditions are satisfied:

$$\begin{matrix}\frac{{L}_{1} {L}_{2} + {L}_{1} {C}_{1} + {L}_{2} {C}_{2}}{{L}_{1} {L}_{2} {C}_{1} {C}_{2}} = {ω}_{1}^{2} ( \begin{matrix}{n}^{2} & {k}^{2}\end{matrix} ) , & ( 41 ) \\ \frac{1}{{L}_{1} {L}_{2} {C}_{1} {C}_{2}} = {n}^{2} {k}^{2} {ω}_{1}^{4} . & ( 42 )\end{matrix}$$

If (41) and (42) conditions are fulfilled, the transconductance G(s) becomes load-independent,

$$G ( s ) = \frac{1}{{L}_{1} {L}_{2} {C}_{1} {s}^{3} + ( {L}_{1} + {L}_{2} ) s} , \qquad ( 43 )$$

which makes possible to command the current of harmonics n and k. After replacing the Laplace operator s with jω:

$$G ( jω ) = j G = j \frac{1}{{L}_{1} {L}_{2} {C}_{1} {ω}^{3} - ( {L}_{1} + {L}_{2} ) ω} , \qquad ( 44 )$$

one can see that transconductance gain G(jω) contains only the imaginary component G, shifting that way the phase of the input voltage harmonic backward or forward for 90°. The gain changes its sign from a negative to a positive for an increasing ω at the anti-parallel resonant frequency:

$${ω}_{r} = \frac{1}{\sqrt{( {L}_{1} □ {L}_{2} ) {C}_{1}}} . \qquad ( 45 )$$

Depending on the position of the particular harmonic frequencies, the gain might be positive or negative. Let us follow a general approach and assume that algebraic values of the gains at resonant frequencies nω₁ and kω₁ have two arbitrary values Gₙ and Gₖ:

$$\begin{matrix}{G}_{n} = \frac{1}{{L}_{1} {L}_{2} {C}_{1} {n}^{3} {ω}_{1}^{3} - n {ω}_{1} ( {L}_{1} + {L}_{2} )} , & ( 46 ) \\ {G}_{k} = \frac{1}{{L}_{1} {L}_{2} {C}_{1} {k}^{3} {ω}_{1}^{3} - k {ω}_{1} ( {L}_{1} + {L}_{2} )} . & ( 47 )\end{matrix}$$

From the previous expressions, the expressions of the parameters of the ladder resonant circuit may be extracted:

$$\begin{matrix}{L}_{1} {L}_{2} {C}_{1} = \frac{1}{{ω}_{1}^{3}} \frac{1}{{k}^{2} - {n}^{2}} ( \frac{1}{k {G}_{k}} - \frac{1}{n {G}_{n}} ) , & ( 48 ) \\ {L}_{1} + {L}_{2} = \frac{1}{{ω}_{1}} \frac{{n}^{2} {k}^{2}}{{k}^{2} - {n}^{2}} ( \frac{1}{{k}^{3} {G}_{k}} - \frac{1}{{n}^{3} {G}_{n}} ) . & ( 49 )\end{matrix}$$

From (41), (42), (48), and (49) the resonant tank elements can be determined as the functions of selected harmonics and transconductances:

$$\begin{matrix}{L}_{1} = \frac{1}{{ω}_{1}} \frac{1}{nk} \frac{( {k}^{2} - {n}^{2} )}{( {nG}_{k} - {kG}_{n} )} , & ( 50 ) \\ {L}_{2} = \frac{{( {nG}_{n} - {kG}_{k} )}^{2}}{{ω}_{1} ( {k}^{2} - {n}^{2} ) {G}_{k} {G}_{n} ( {kG}_{n} - {nG}_{k} )} , & ( 51 ) \\ {C}_{1} = \frac{1}{{ω}_{1}} \frac{1}{{k}^{2} - {n}^{2}} \frac{{( {kG}_{n} - {nG}_{k} )}^{2}}{( {kG}_{k} - {nG}_{n} )} , & ( 52 ) \\ {C}_{2} = \frac{( {k}^{2} - {n}^{2} ) {G}_{k} {G}_{n}}{{ω}_{1} nk ( {nG}_{n} - {kG}_{k} )} . & ( 53 )\end{matrix}$$

After studying the previous four equations, it is easy to see that they can result in positive values for circuit elements only if Gₙ and Gₖ have different signs. Taking into account the shape of the G(ω) curve, it would be possible if the resonant frequencies (nω₁) are at the different sides of the anti-parallel resonance ωᵣ (nω₁<ωᵣ<kω₁), which results in Gₙ<0<Gₖ. It is not difficult now to see that the previous relation is also a sufficient condition to have all positive values of the designed inductors and capacitors.

The equations (50)-(53) represent a sufficient set of equation for the receiver design and do not depend on R_{ac,p}, which makes the proposed design to be load-independent. However, they assume that coil inductance L₁ is a designing parameter, which may not be true if the objective is to develop a compensation circuit for an existing receiving coil. In that case, the frequency ω₁ might be varied to satisfy (50). If even the ω₁ is predetermined and cannot be adjusted, the system does not have enough parameters to control both resonant frequencies and transconductances. Then, only the ratio between the two transconductances could be specified, and the equation (50) could be then used to calculate actual transconductances.

To complete this general analysis, let us derive the expression for the input impedance of the resonant tank and the approximate values of the resistances and reactances transferred back into primary circuit at resonant frequencies nω₁ and kω₁. The input impedance, expressed in terms of the circuit parameters is:

$${Z}_{in} ( s ) = \frac{{L}_{1} {L}_{2} {C}_{1} {C}_{2} {R}_{ac} {s}^{4} + {L}_{1} {L}_{2} {C}_{1} {s}^{3} + {R}_{ac} ( {L}_{1} {C}_{2} + {L}_{1} {C}_{1} + {L}_{2} {C}_{2} ) {s}^{2} + ( {L}_{1} + {L}_{2} ) s + {R}_{ac}}{{L}_{2} {C}_{1} {C}_{2} {R}_{ac} {s}^{3} + {L}_{2} {C}_{1} {s}^{2} + ( {R}_{ac} {C}_{2} + {C}_{1} {R}_{ac} ) s + 1} . \qquad ( 54 )$$

At resonant frequencies (54) becomes simpler since even order terms in the nominator disappear and odd terms constitute the transconductance G(s):

$${Z}_{in} ( s ) = \frac{1}{G ( s )} \frac{1}{{L}_{2} {C}_{1} {C}_{2} {R}_{ac , p} {s}^{3} + {L}_{2} {C}_{1} {s}^{2} + ( {R}_{ac} {C}_{2} + {C}_{1} {R}_{ac , p} ) s + 1} . \qquad ( 55 )$$

The next step is to derive the expressions for the impedances reflected to the primary side of the system, by using an approximate formula:

$${Z}_{ref , p} ( j p {ω}_{1} ) = {R}_{ref , p} ( p {ω}_{1} ) + j {X}_{ref , p} ( p {ω}_{1} ) = \frac{{( p {ω}_{1} )}^{2} {M}^{2}}{{Z}_{in} ( j p {ω}_{1} )} = pn , k . \qquad ( 56 )$$

where M is the mutual inductance of primary and secondary coils. It may result in the following expressions:

$$\begin{matrix} {R}_{ref , n} ( n {ω}_{1} ) = {( n {ω}_{1} )}^{2} {M}^{2} {G}_{n}^{2} {R}_{ac , n} , & ( 57 ) \\ {X}_{ref , n} ( n {ω}_{1} ) = \frac{{( n {ω}_{1} )}^{2} {M}^{2}}{{( {k}^{2} - {n}^{2} )}^{2} {G}_{k}} [ ( {k}^{4} 3 {k}^{2} {n}^{2} ) {G}_{k} {G}_{n} - {n}^{3} {kG}_{k}^{2} + {n}^{3} {kG}_{n}^{2} ] , & ( 58 ) \\ {R}_{ref , k} ( k {ω}_{1} ) = {( k {ω}_{1} )}^{2} {M}^{2} {G}_{k}^{2} {R}_{ac , k} , & ( 59 ) \\ {X}_{ref , k} ( k {ω}_{1} ) = \frac{{( k {ω}_{1} )}^{2} {M}^{2}}{{( {k}^{2} - {n}^{2} )}^{2} {G}_{k}} [ ( {n}^{4} 3 {k}^{2} {n}^{2} ) {G}_{k} {G}_{n} - {k}^{3} n ( {G}_{k}^{2} + {G}_{n}^{2} ) ] & ( 60 )\end{matrix}$$

Although these general expressions for a two-frequency systems are useful, the analysis that follow may be focus on one specific system: the system that exploits the first and the third harmonic of the input signal to transfer the power to the load (n=1, k=3). Since this is, according to our best knowledge, the first system that uses more than one frequency to transfer power wirelessly, the selected frequencies represent a natural extension from the traditional system that uses only one, base frequency.

For a specified values of R_{ac,p}, the harmonics current I_{ac,1} and I_{ac,3} are the main quantities that determine delivered power:

Pₒᵤₜ=P_{ac} R_{ac,1}=I_{ac,1}² R_{ac,3}I_{ac,3}^{2+.} (61)

However, they require the transconductances G₁ and G₃ to be selected a priori. If the open- circuit voltages V_{oc,1} and V_{ac,3} are known, or at least their ratio m_{V,oc}, by choosing the transconductances, the sharing of the delivered power among the two frequencies may be controlled:

Pₒᵤₜ= =P_{ac}+R_{ac,1}G₁²V_{oc,1}²=R_{ac,3}+G₃²V_{oc,3}² V_{oc,1}²(R_{ac,1}G₁²R_{ac,3}G₃²m_{V,oc}²). (62)

For the further discussion, it is important to define the ratio of the currents I_{ac,1} and I_{ac,3} and denote it by m_{I,ac}:

$${m}_{I , ac} = \frac{{I}_{ac , 3}}{{I}_{ac , 1}} . \qquad ( 63 )$$

For the constant open-circuit voltages, a properly designed system may comply designers requirements to generate the specified current ratio m_{I,ac}. At this point, it is important for the reader to note that a diode bridge operation is determined by the voltage at its input side, not by current. Therefore, the resonant tank has to profile its output voltage V_{ac} to indirectly achieve the required ratio of the current harmonics.

The design procedure, as it is explained above, is able to adjust the magnitude of the transconductance G, while the phase is out of our control and has 90° value for Gₖ and −90° for Gₙ. Consequently, the phases of current harmonics I_{ac,1} and I_{ac,3} are not adjustable parameters, and they are completely determined by the phases of the input voltages V_{oc,1} and V_{oc,3}:

$$\begin{matrix}{θ}_{Iac , 1} [ 0 ] = {θ}_{Voc , 1} [ 0 ] {90}^{°} \\ {θ}_{Iac , 3} [ 0 ] = {θ}_{Voc , 3} [ 0 ] {90}^{°}\end{matrix} \qquad ( 64 )$$

It is important at this point to mention the following side note: although the calculation of each individual phase angle for the harmonics obeys the well-known rules, one should be particularly careful when comparing the phases of different harmonics. Indeed, some conventions that are valid for the same frequency in terms of the phase shift and mutual signals position may not be in charge when different harmonics are analyzed. For example, phase shift of 90° degrees of both the first and the third harmonics do not maintain the mutual position of the signal, as it would be if they had the same frequency. Luckily, in the discussion below, only two distinctive situations may be interesting. Using the voltage signal V_{ac} as the example, the first one can be defined as the position of the harmonics that results in positive parameter m_{V,ac} in (26), while the second one is determined by a negative value of the m_{V,ac}. The similar definition can be used for other voltage and current multi-harmonic signals. Keeping this addendum in mind, “in-phase” term may be used to describe m_{V,ac}>0 case, and “anti-phase” to correspond to m_{V,ac}<0.

As described herein, the design of the primary (transmitter) is discussed, it may be clear that V_{oc,1} and V_{oc,3} can only appear in two distinctive mutual position: they can be in-phase or anti-phase, referring to the definition of these two terms given above. The anti-phase of the voltage harmonics and the phase shift defined by (64) may result in the in-phase current I_{ac,1} and I_{ac,3}, while the in-phase input voltage signals may force the same currents to accept anti-phase mutual position.

The ratio between the third and the first harmonic of a square wave is m_{I,ac}=1/3 as shown in 11A. Consequently, for any ratio different than 1/3, the voltage at the input of the rectifier has to modify the I_{ac} by inserting an additional voltage zero-crossings, and changing the sign of I_{ac} for interval (θ_{z}, π−θ_{z}) for M_{I,ac}>1/3, and interval (π−θ_{z}, π+θ_{z}) for m_{I,ac}<1/3, as it is exemplified in. In the same figure for each of the periodic current waveforms the expansions into Fourier series are given.

With the understanding of the diode bridge operation, nowexpressions of the equivalent resistances at the first and the third harmonics may be derived. Let us assume that the ratio of the current harmonics m_{I,ac} and the equivalent dc resistance R_{dc}=V_{dc}/I_{dc,avg} are known.

According to the expressions given in 11B and 11C, the ratio m_{I,ac} can be written as:

$${m}_{I , ac} = \frac{{I}_{ac , 3}}{{I}_{ac , 1}} = \frac{1}{3} \frac{1 - 2 cos ( 3 {θ}_{z} )}{1 - 2 cos ( {θ}_{z} )} = \frac{1}{3} \frac{1 - 2 [ 4 {cos}^{3} {θ}_{z} - 3 cos {θ}_{z} ]}{1 - 2 cos ( {θ}_{z} )} . \qquad ( 65 )$$

By substituting the cosine function with a variable t, a cubic equation may be obtained:

−8t³+6t(1+m_{I,ac})+1−3m_{I,ac}=0. (66)

The previous cubic equation has an analytical solution, and it is given by (67). Exactly one of the zeros is real and in the range t∈[0, 1], which corresponds to the angular range 0_{z}∈[0, π/2]. One should be careful while applying the explicate solution (67), since it is valid only while the expression under the square root is positive. When it becomes negative, MATLAB function roots( ) or some other numerical method of solving may be an option.

$$a = - 8 \\ c = 6 ( 1 + {m}_{1 , ac} ) \\ d = 1 - 3 {m}_{1 , ac} \\ {t}_{1} = \frac{1}{3 a} ( \sqrt[3]{0.5 + [ 27 {a}^{2} d + \sqrt{{27}^{2} {a}^{4} {d}^{2} + 108 {a}^{3} {c}^{3}} ]} \sqrt[3]{0.5 - [ 27 {a}^{2} d + \sqrt{{27}^{2} {a}^{4} {d}^{2} 108 {a}^{3} {c}^{3}} ]} ) \\ {t}_{2} = \frac{1 - i \sqrt{3}}{6 a} \sqrt[3]{0.5 [ 27 {a}^{2} d \sqrt{{27}^{2} {a}^{4} {d}^{2} + 108 {a}^{3} {c}^{3}} ]} + \frac{1 + i \sqrt{3}}{6 a} \sqrt[3]{0.5 + [ 27 {a}^{2} d - \sqrt{{27}^{2} {a}^{4} {d}^{2} + 108 {a}^{3} {c}^{3}} ]} \\ {t}_{3} = \frac{1 + i \sqrt{3}}{6 a} \sqrt[3]{0.5 [ 27 {a}^{2} d + \sqrt{{27}^{2} {a}^{4} {d}^{2} + 108 {a}^{3} {c}^{3}} ]} + \frac{1 - i \sqrt{3}}{6 a} \sqrt[3]{0.5 [ 27 {a}^{2} d - \sqrt{{27}^{2} {a}^{4} {d}^{2} + 108 {a}^{3} {c}^{3}} ]} \\ {θ}_{z} = {cos}^{- 1} ( {t}_{i} ) i = 1 , 2 , 3 \qquad ( 67 )$$

In order to have the specified ratio between the third and first harmonics m_{I,ac}, the ac current I_{ac} should have the transition from −I_{dc,avg}, to I_{dc,avg} and vice versa at the specified positions inside a period of the signal. However, the current is not the one that forces the diode bridge to switch its state at these particular time instants—it is done by voltage V_{ac}. The voltage V_{ac} consists dominantly of the first and the third harmonics in-phase or in anti-phase:

V_{ac}(t)=\sqrt{2}V_{ac,1}(sin(ω₁t)+m_{V,ac} sin(3ω₁t)), (68)

where m_{V,ac} is positive when the harmonics are in-phase and negative when they are in anti-phase. Voltage zero-crossings are uniquely determined by the ratio of the harmonics amplitudes (or rms values) m_{V,ac}. Therefore, m_{V,ac} may be set to an appropriate value to achieve the zero-crossings at positions 0, θ_{z}, π−θ_{z} and periodically further on:

sin(θ_{z})+m_{V,ac} sin (3θ_{z})=0, (69)

which results in:

$${m}_{V , ac} = \frac{1}{- 3 + 4 {sin}^{2} {θ}_{z}} . \qquad ( 70 )$$

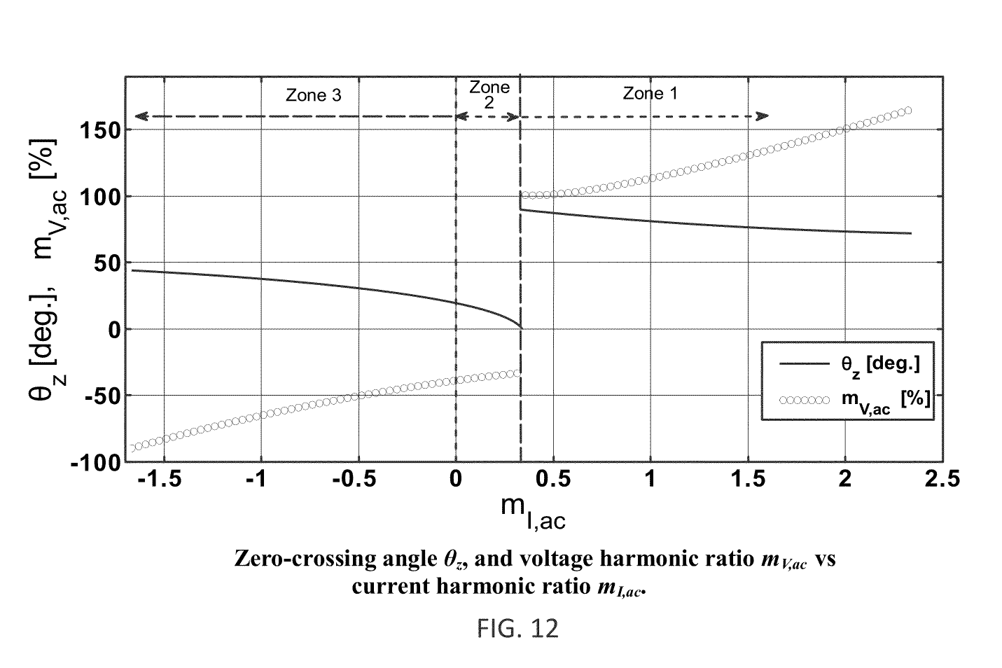

It may be interesting to show the zero-crossing angle θ_{z} and voltage ratio m_{V,ac} as the functions of the designing parameter m_{I,ac}, and it is shown in FIG. 12. As exemplified in FIG. 12, for m_{I,ac}<1/3 (corresponds to Zone 2 and Zone 3 in FIG. 12), angle θ_{z} is smaller than 600 and consequently the voltage ratio m_{V,ac} is negative. Besides it negative sign, the m_{V,ac} is smaller than 100% which indicate that the third harmonic is smaller than the first one. For m_{I,ac}>1/3 (corresponds to Zone 1 in FIG. 12), the angle θ_{z} is greater than 600 (implying the positive sign of m_{V,ac}) and third voltage harmonic is greater than the first one.

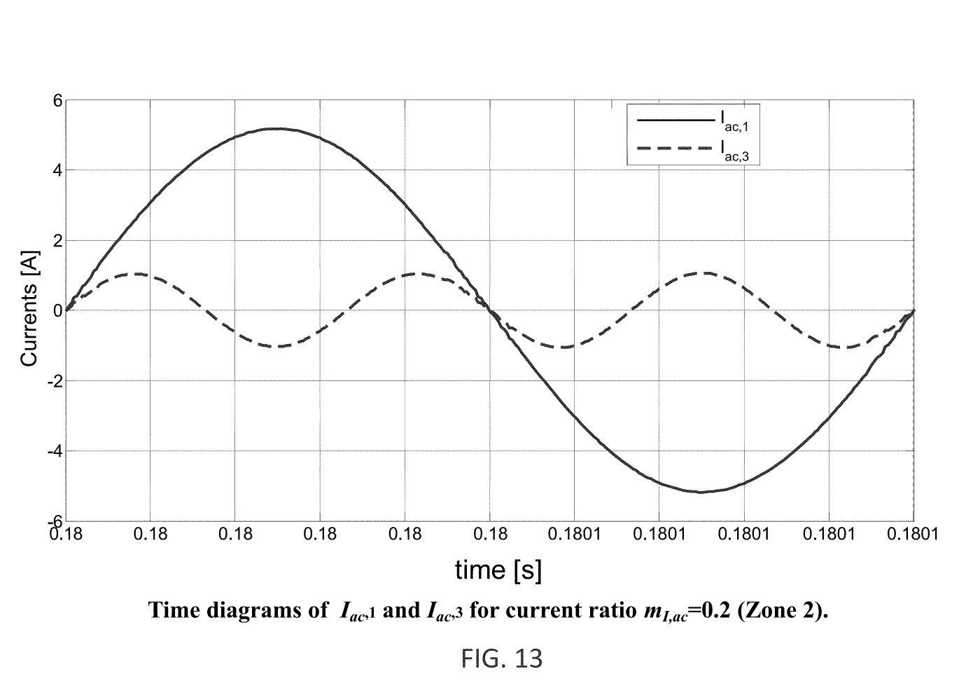

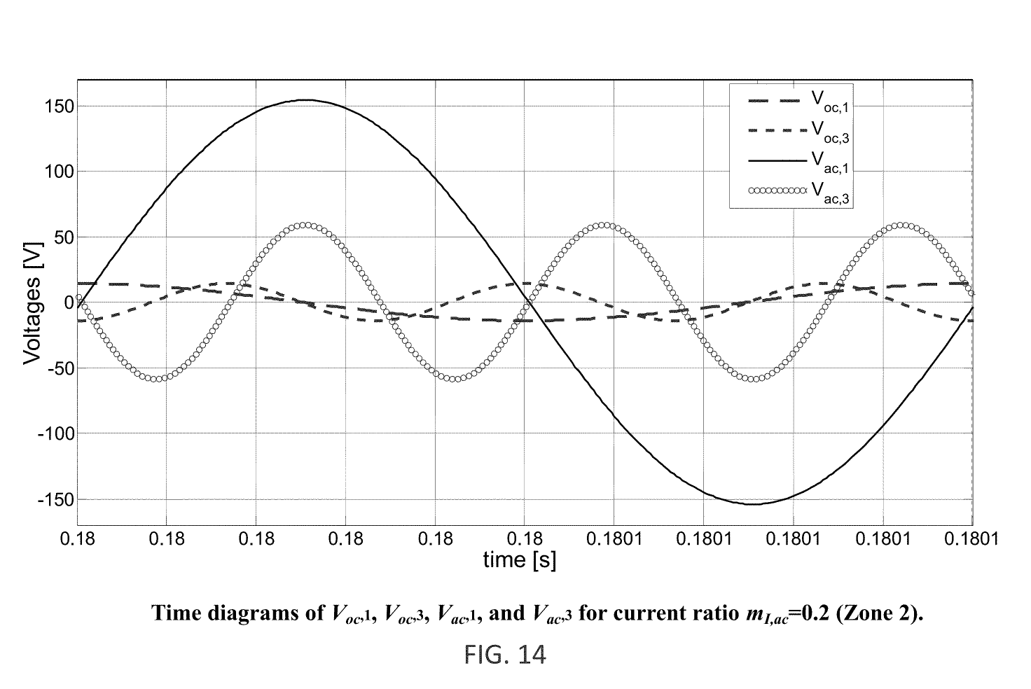

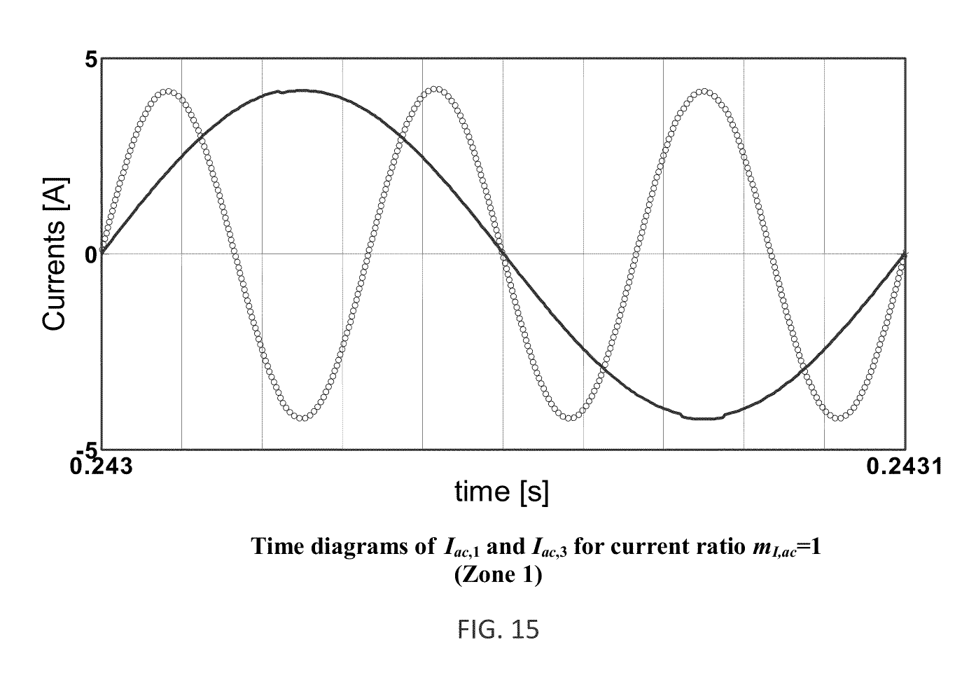

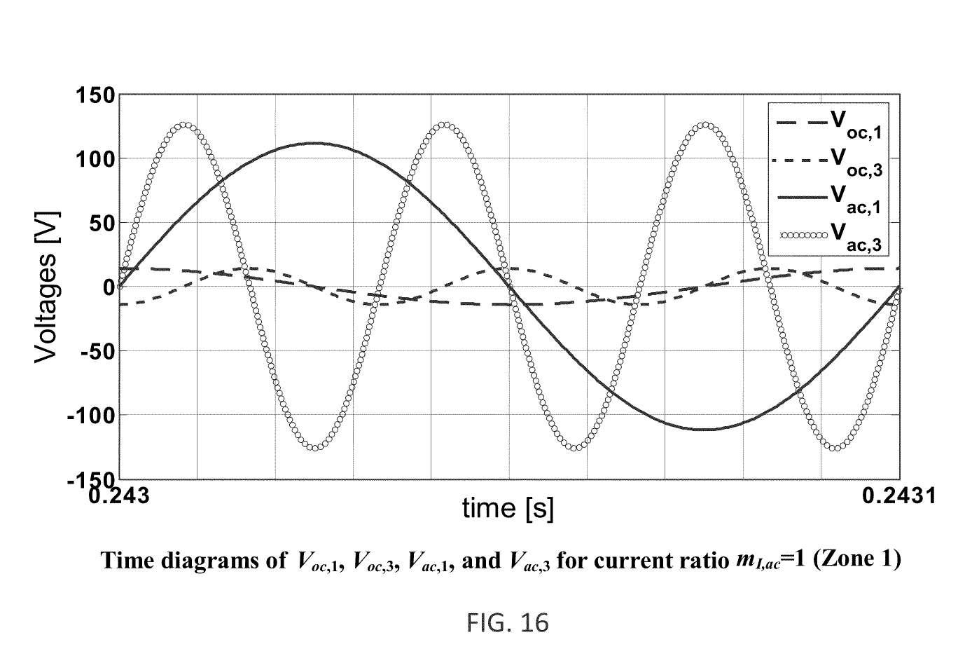

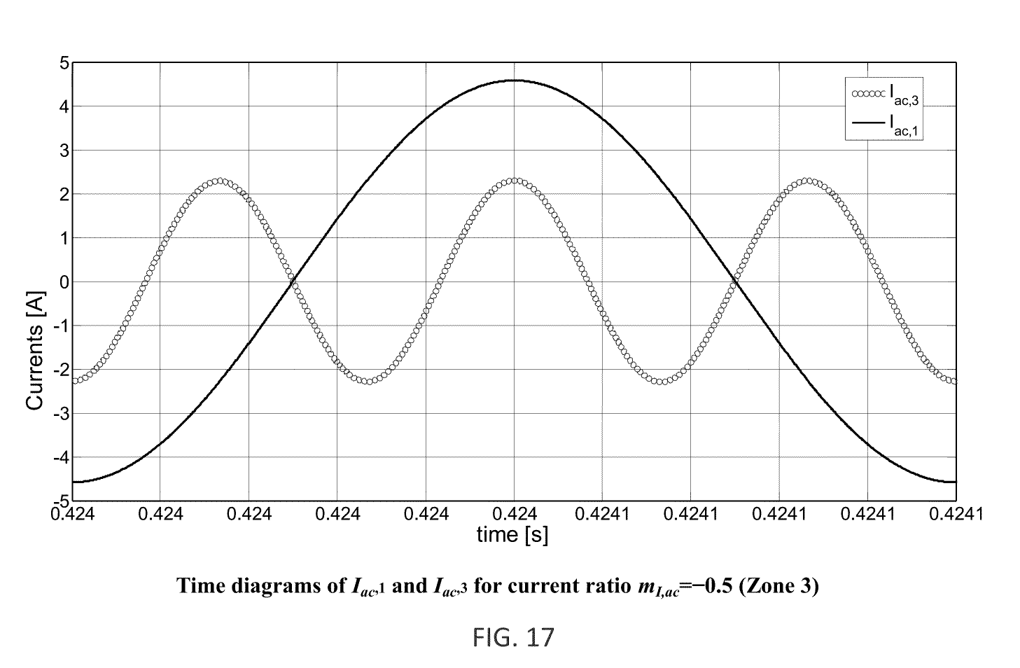

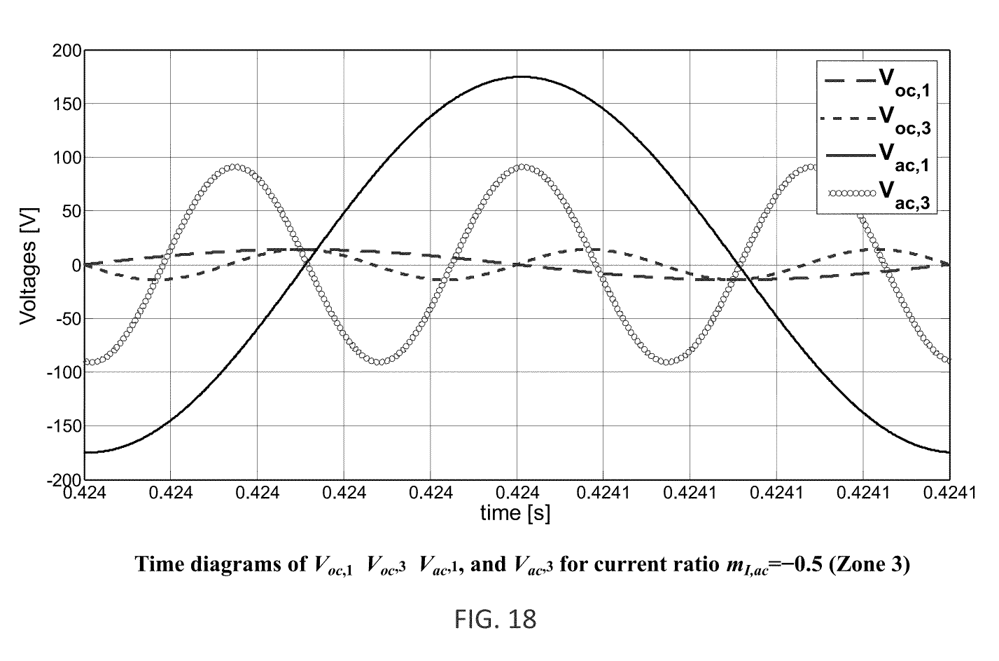

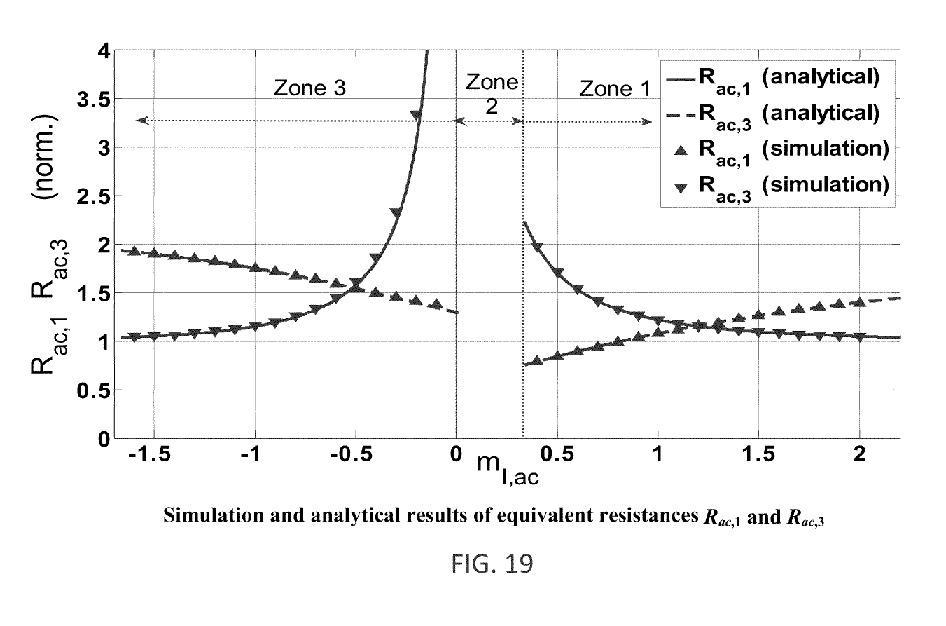

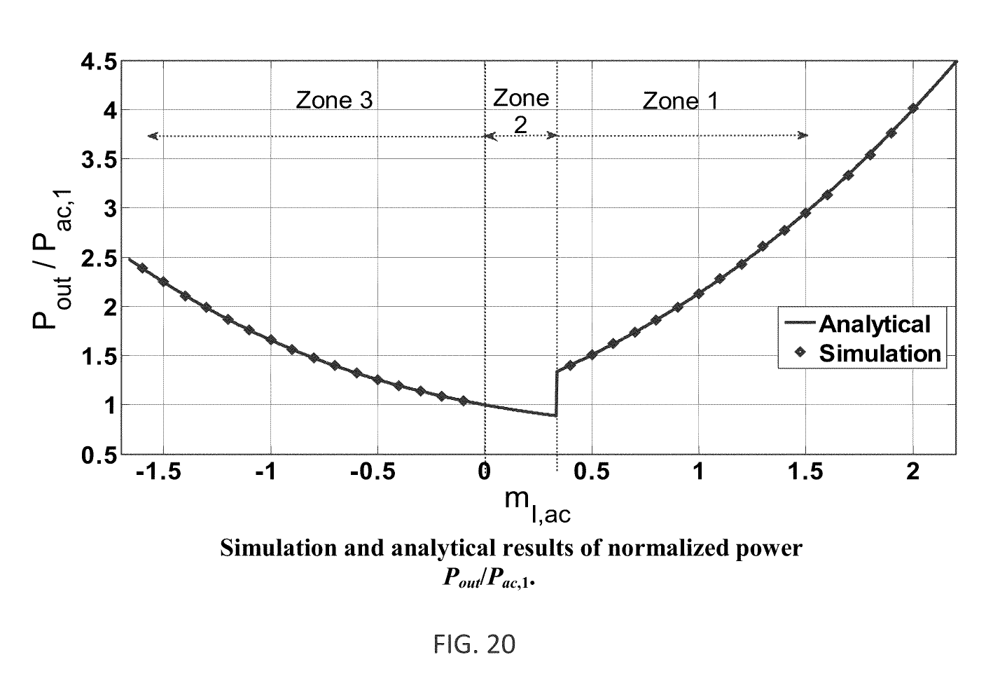

The operation of the system in these three zones is demonstrated in the exemplary FIGS. 13 to 18 where timing diagrams of I_{ac,1}, I_{ac,3}, V_{oc,1}, V_{oc,3}, V_{ac,1}, and V_{ac,3}, are shown for V_{oc,1}=10V (rms), and V_{oc,3}=10V (rms) during a selected one-period-long time interval. The graphs shown are taken from the exemplary Simulink model of a 500 W, 10 kHz system that may be disclosed in more detail below. The previous observations lead to three very important conclusions:
Operation in Zone 2 is demonstrated in FIG. 13 and for an exemplary m_{I,ac}=0.2 designed value of the current ratio. The diagrams confirm the disclosed above, related to mutual phase position of the signals. 180° phase shift of the signals I_{ac,3} and V_{oc,3} coincides to a negative equivalent resistance (R_{ac,3}<0) which means that the third harmonic transfers the real power in the opposite direction, from the load to the primary of the IPT system. Certainly, it is not a desirable operational condition, since then the proposed system that exploits two harmonics, transfers less power and produces more losses than a single-frequency-based system.
When m_{I,ac} is greater than 1/3 (Zone 1), the all four ac signals I_{ac,1}, I_{ac,3}, V_{ac,1}, and V_{ac,3} are in-phase. It results in positive values of R_{ac,1} and R_{ac,3} and consequently in proper direction of the power flow at both resonant frequencies. Again, the results of a 500 W 10 kHz Simulink model are used to support this discussion in the similar way it was done for 0<m_{I,ac}<1/3 range earlier. m_{I,ac}>1/3 operation regime is demonstrated in and for m_{I,ac}=1.
For the parameter m_{I,ac} in Zone 3, each voltage-current pair (I_{ac,1}-V_{ac,1} i and I_{ac,3}-V_{ac,3}) is in phase, although the voltages or current are not by themselves. Consequently, it results again in positive R_{ac,1} and R_{ac,3}, and a wanted direction of the power flow. This operation mode is illustrated in and 0.18 for m_{I,ac}=−0.5.
Taking into account the previous observations, portions of the rest of this disclosure may be focused on different cases when m_{I,ac}>1/3 or m_{I,ac}<0. Since the resonant, design in the identical way for both these two operational regimes, introduces +90° phase shift for the third harmonic and −90° for the first one, one can conclude that only two particular mutual phase positions of the open-circuit voltage result in operation in Zone 1 or Zone 3. Indeed, to make the system operate in-phase after the resonant tank (Zone 1), the open-circuit voltages V_{oc,1} and V_{oc,3} have to have phases +90° and −90°, respectively. The operation of V_{ac,1} and V_{ac,3} in an anti-phase (Zone 3) requires the phases of the open-circuit voltages V_{oc,1} and V_{oc,3} to be 0° and 180°, respectively. As disclosed further herein, the design of the transmitter circuit results in exactly these two phase constellations, which gave us the right to proceed further by analyzing both of these two operational modes.

The next important step is to derive the expressions for R_{ac,1} and R_{ac,3} and determine how the two harmonics share the power transferred to the load as a function of the voltage and current ratios m_{I,ac} and m_{V,ac}. Since the derivation process is quite long, to keep smooth flow of this discussion, it is disclosed below, while in this section only the final expression are rewritten due to completeness:

$$\begin{matrix} {R}_{ac , 1} = \frac{{π}^{2}}{8} {R}_{L} \frac{( 1 + {m}_{1 , ac} {m}_{V , ac} )}{{( 1 + \frac{{m}_{V , ac}}{3} + 2 \frac{{m}_{V , ac} - 1}{3} \sqrt{\frac{{m}_{V , ac} - 1}{{m}_{V , ac}}} )}^{2}} , & ( 71 ) \\ {R}_{ac , 3} = \frac{{m}_{V , ac}}{{m}_{I , ac}} {R}_{ac , 1} = \frac{{π}^{2}}{8} {R}_{L} \frac{{m}_{V , ac}}{{m}_{I , ac}} \frac{( 1 + {m}_{I , ac} {m}_{V , ac} )}{{( 1 + \frac{{m}_{V , ac}}{3} + 2 \frac{{m}_{V , ac} - 1}{3} \sqrt{\frac{{m}_{V , ac} - 1}{{m}_{V , ac}}} )}^{2}} , & ( 72 ) \\ {P}_{out} = {P}_{ac , 1} ( 1 + {m}_{V , ac} {m}_{I , ac} ) & ( 73 )\end{matrix}$$

Although it seems that R_{ac,1} and R_{ac,3} depends on two parameters m_{I,ac} and m_{V,ac}, it should not be forgotten that there is a direct, one-to-one relation between m_{I,ac} and m_{V,ac} given by (67) and (70) above. It further means that for a designed system with specified G₁ and G₃, only the input, open-circuit voltages determine power sharing and resonant resistances.

In 19 and 20, the analytical and simulation results are presented for R_{ac,1}, R_{ac,3} and Pₒᵤₜ. However, instead to plot the absolute values, each of them is normalized: the resistances are normalized by (8/π²/R_{L}), while the ratio Pₒᵤₜ/P_{ac,1} is shown instead of Pₒᵤₜ. Exemplary simulation results are extracted from V_{ac}(t) and I_{ac}(t) by using Simulink block for Fourier analysis, followed by a block for division of magnitudes of the appropriate voltage and current harmonics. The figures show an excellent matching between the analytical expectations and simulation results.

Before continuing with a case study of a multi-resonant receiver, let us examine the reflected impedances Z_{ref,1} and Z_{ref,3} when the first and third harmonics are applied. For n=1 and k=3, the equations (57) (60) becomes:

$$\begin{matrix}{R}_{ref , 1} ( {ω}_{1} ) = {ω}_{1}^{2} {M}^{2} {G}_{1}^{2} {R}_{ac , 1} , & ( 74 ) \\ {X}_{ref , 1} ( {ω}_{1} ) = \frac{3 {( {ω}_{1} )}^{2} {M}^{2}}{64 {G}_{3}} [ 18 {G}_{1} {G}_{3} + {G}_{3}^{2} + {G}_{1}^{2} ] , & ( 75 ) \\ {R}_{ref , 3} ( 3 {ω}_{1} ) = {( 3 {ω}_{1} )}^{2} {M}^{2} {G}_{3}^{2} {R}_{ac , 3} , & ( 76 ) \\ {X}_{ref , 3} ( k {ω}_{1} ) = \frac{{( 3 {ω}_{1} )}^{2} {M}^{2}}{64 {G}_{1}} [ - 26 {G}_{1} {G}_{3} + 27 ( {G}_{1}^{2} + {G}_{3}^{2} ) ] . & ( 77 )\end{matrix}$$

Based on the previous expressions, some interesting observations can be made:
The ratio of the resistances reflected back into the primary circuit can be expressed as:

$$\frac{{R}_{ref , 3}}{{R}_{ref , 1}} = \frac{9 {G}_{3}^{2} {R}_{ac , 3}}{{G}_{1}^{2} {R}_{ac , 1}} . \qquad ( 78 )$$

If, for example, the absolute values of the transconductances are the same (G₃=−G₁=G>0) and m_{I,ac} is close to 0.9 (where both harmonics deliver approximately the same power), the equivalent transferred resistance at third harmonic may be approximately 11 times greater than the one at the first harmonic: R_{ac,3}≈11R_{ac,1}.
Reflected reactance at 3ω₁, X_{ref,3}, is capacitive, regardless of the values of transconductances, while X_{ref,1} is capacitive, but for an limited range of transconductances: G₃<(9−4□5)*|G₁|. Although the range for X_{ref,1} is restricted, it typically includes all designs of a practical importance.
Practical designs very often utilize the identical primary and secondary coils Lₚ=L₁. In that case, the coupling between the coils can be effectively described by using a coupling coefficient k_{c}: M=k_{c}Lₚ. For this particular case, it would be interesting to compare the inductance of the primary coil Lₚ and the reflected “negative inductance” since it would represent an detuning for the primary circuit. From (75) and (77) the ratio can be written as:

$$\begin{matrix}\frac{Δ {L}_{p}}{{L}_{p}} ( {ω}_{1} ) = \frac{{X}_{ref , 1} ( {ω}_{1} ) / {ω}_{1}}{{L}_{p}} = \frac{3}{64} {k}_{c}^{2} {ω}_{1} {L}_{p} \frac{18 {G}_{1} {G}_{3} + {G}_{3}^{2} + {G}_{1}^{2}}{{G}_{3}} , & ( 79 ) \\ \frac{Δ {L}_{p}}{{L}_{p}} ( 3 {ω}_{1} ) = \frac{{X}_{ref , 1} ( 3 {ω}_{1} ) / 3 {ω}_{1}}{{L}_{p}} = \frac{3}{64} {k}_{c}^{2} {ω}_{1} {L}_{p} \frac{- 26 {G}_{1} {G}_{3} + 27 ( {G}_{1}^{2} + {G}_{3}^{2} )}{{G}_{1}} . & ( 80 )\end{matrix}$$

Considering (50) for n=1 and k=3, the inductance Lₚ may be:

$${L}_{p} = {L}_{1} = \frac{1}{3 {ω}_{1}} \frac{8}{( {G}_{3} - 3 {G}_{1} )} . \qquad ( 81 )$$

It finally leads to the expression for detuning ratio of the primary inductance of:

$$\begin{matrix}\frac{Δ {L}_{p}}{{L}_{p}} ( {ω}_{1} ) = \frac{1}{8} {k}_{c}^{2} \frac{18 {G}_{1} {G}_{3} + {G}_{3}^{2} + {G}_{1}^{2}}{{G}_{3}^{2} - 3 {G}_{1} {G}_{3}} & ( 82 ) \\ \frac{Δ {L}_{p}}{{L}_{p}} ( 3 {ω}_{1} ) = \frac{1}{8} {k}_{c}^{2} \frac{- 26 {G}_{1} {G}_{3} + 27 ( {G}_{1}^{2} + {G}_{3}^{2} )}{{G}_{1} {G}_{3} - 3 {G}_{1}^{2}} . & ( 83 )\end{matrix}$$

To develop the sense of relative detuning, let us calculate the previous expressions for G₃=−G₁ and coupling coefficients of k_{c}=0.1:

$$\begin{matrix}\frac{Δ {L}_{p}}{{L}_{p}} ( {ω}_{1} , {G}_{3} = - {G}_{1} , {k}_{c} = 0.1 ) = - 0.5 \% , & ( 84 ) \\ \frac{Δ {L}_{p}}{{L}_{p}} ( 3 {ω}_{1} , {G}_{3} = - {G}_{1} , {k}_{c} = 0.1 ) = - 2.5 \% . & ( 85 )\end{matrix}$$

Let us apply the theoretical analysis presented in the previous section to design an exemplary receiver for multi-resonant IPT.

The goal is to design an exemplary receiver that exploits the first and third harmonics to supply Pₒᵤₜ=500 W to a resistive load of nominal value R_{L}=20Ω. The self-inductance of the receiving coils is measured at L₁=34.76 μH. Although the open-circuit voltages V_{oc,1} and V_{oc,3} depends on the designed based frequency that has been determined yet, let assume that they can be adjusted to V_{oc,1}=V_{oc,3}=10 V (rms) values by changing the primary current for any base frequency in the range f₁∈(9 kHz, 11 kHz). It would be desirable to design the system whose quality factors at both resonant frequencies and nominal load stay less than 10 (a value from experience), since it would result in a resonant tank less sensitive to detuning

### Step 1: Determining the Equivalent Resistances R_{ac.1} and R_{ac,3};

Since the induced voltages are equal, it is reasonable to preserve this balance it terms of power delivered to the load at both frequencies as well. Therefore,

$${P}_{ac , 1} = {P}_{ac , 3} \frac{{P}_{out}}{2} = 250 W . \qquad ( 86 )$$

will be chosen as the way of sharing power. By reading the value at the abscissa axis for ordinate value of 2 in, it is easy to obtain the value of the parameter m_{I,ac} that provides equal power sharing (Zone 1 operation):

$${m}_{I , ac} ( \frac{{P}_{out}}{{P}_{ac , 1}} = 2 ) = 0.907 . \qquad ( 87 )$$

The ac current ratio can be now substituted into the set of equations (67) to calculate the zero-crossing position θ_{z} of the total ac voltage:

θ_{z}(m_{I,ac}=0.9066) 81.21°. (88)

Angle θ_{z} can be used as the input for (70) to get the ac voltage ratio m_{V,ac}:

m_{V,ac}(θ_{z}=81.21°)1.103. (89)

A shortcut to the same outcome of m_{V,ac} might be the application of (73) which would give m_{V,ac} directly, if power and current ratio are known. Finally, the equivalent resistances may be obtained from (71) and (72):

R_{ac,1}(m_{I,ac}0.90,m_{V,ac} =1.103,R_{L =}20Ω)=25.59Ω, (90)

R_{ac,3}(m_{I,ac}=0.907, m_{V,ac} =1.103, R_{L} =20Ω)=31.135Ω, (91)

### Step 2: Calculation of Transconductances G₁ and G₃;

Since the transconductances represents the ratio of the ac current and open-circuit voltages, the currents from the power delivered may be calculated:

$$\begin{matrix}{I}_{ac , 1} = \sqrt{\frac{{P}_{ac , 1}}{{R}_{ac , 1}}} = 3.126 A , & ( 92 ) \\ {I}_{ac , 3} = \sqrt{\frac{{P}_{ac , 3}}{{R}_{ac , 3}}} = 2.834 A . & ( 93 )\end{matrix}$$

The transconductances may be then:

$$\begin{matrix}{G}_{1} = - \frac{{I}_{ac , 3}}{{V}_{ac , 3}} = - 0.313 S ⇒ {G}_{1} = jG = - j .313 S , & ( 94 ) \\ {G}_{3} = \frac{{I}_{ac , 3}}{{V}_{ac , 3}} = 0.283 S ⇒ {G}_{3} {jG}_{3} = j0 .283 S . & ( 95 )\end{matrix}$$

At this point it may be advantageous to check the values of the quality factors Q₁ and Q₃ at resonant frequencies.

Q₁=|G₁|R_{ac,3} 8, (96)

Q₃=G₃R_{ac,3} 8.82. (97)

### Step 3: Design of the Resonant Circuit L₂, C₁ and C₂;

Since in our problem the base frequency is unknown, the equation needs to be rearranged to allow calculation of f₁ instead of L₁:

$${f}_{1} = \frac{4}{3 π} \frac{1}{{L}_{1}} \frac{1}{( {G}_{3} - 3 {G}_{1} )} = 10 kHz . \qquad ( 98 )$$

Now (51)-(53) can be used further to determine the other elements:

L₂=24.87 μH

C₁=2.551 μF.

C₂=3.233 μF (99)

As one way to validate the analytical derivations disclosed herein, a Simulink model has been built and this particular operational condition is simulated. Since there was no an analytical method that may easily include the losses into calculation, they are removed from the Simulink model as well. The result of the analytically obtained values and corresponding values extracted from the simulation results are comparatively shown in Table 3. As, one can see, there is an excellent matching between them, which indirectly proves the presented methodical approach.

In a similar manner a system can be designed that operates in Zone 3.

TABLE 3
Receiver - a comparative presentation of the
analytical and simulation results

| Parameter | Analysis | Simulation | Parameter | Analysis | Simulation |
|---|---|---|---|---|---|
| Vₒᵤₜ [V] | 100 | 100.03 | m_{I,ac} | 0.907 | 0.907 |
| Pₒᵤₜ [W] | 500 | 500.3 | m_{V,ac} | 1.103 | 1.105 |
| I_{ac,1} [A] | 3.126 | 3.125 | R_{ac,1} [Ω] | 25.59 | 25.59 |
| I_{ac,3} [A] | 2.834 | 2.833 | R_{ac,3} [Ω] | 31.14 | 31.19 |
| V_{ac,1} [V] | 80 | 79.97 | R_{in,1} [Ω] | 0.397 | 0.397 |
| V_{ac,3} [V] | 88.22 | 88.39 | X_{in,1} [Ω] | 0.037 | 0.032 |
| P_{ac,1} [W] | 250 | 250 | R_{in,3} [Ω] | 0.392 | 0.388 |
| P_{ac,3} [W] | 250 | 250.3 | X_{in,3} [Ω] | 0.056 | 0.068 |

Since the structure and behavior of a multi-resonant receiver is recognized, the next step is to develop a corresponding multi-resonant transmitter structure that may be able to excite receiver coil at certain frequencies and deliver the power. A general topology of the transmitter usually contains a high-frequency power converter, compensation circuit and the primary coil or track. The input power converter generates the excitation voltage that supplies the compensation circuit and the transmitter coil. The output voltage of the converter can be regulated by the phase shift control. The advantage of this control method is that it allows regulation of the voltage and indirectly the current of the primary coil. This may complicate the system and reduces the utilization of the converter rated power which may lead to a reduced efficiency. One or more applications of the phase shift control may be provided in an open loop control configuration to reduce certain harmonics (typically the third one) by selecting a suitable value of the phase angle. To the contrary, the design described herein may exploit the existence of the voltage harmonics.

With the dead-time interval neglected, the square wave inverter output voltage can be represented by the following Fourier series expression:

$${V}_{inv} ( t ) = \frac{4 {V}_{dc}}{π} {\sum }_{k = 1 , 3 , 5 , …}^{+ ∞} \frac{sin ( \frac{k π D}{2} ) sin ( \frac{k π}{2} )}{k} sin ( k ω t ) . \qquad ( 100 )$$

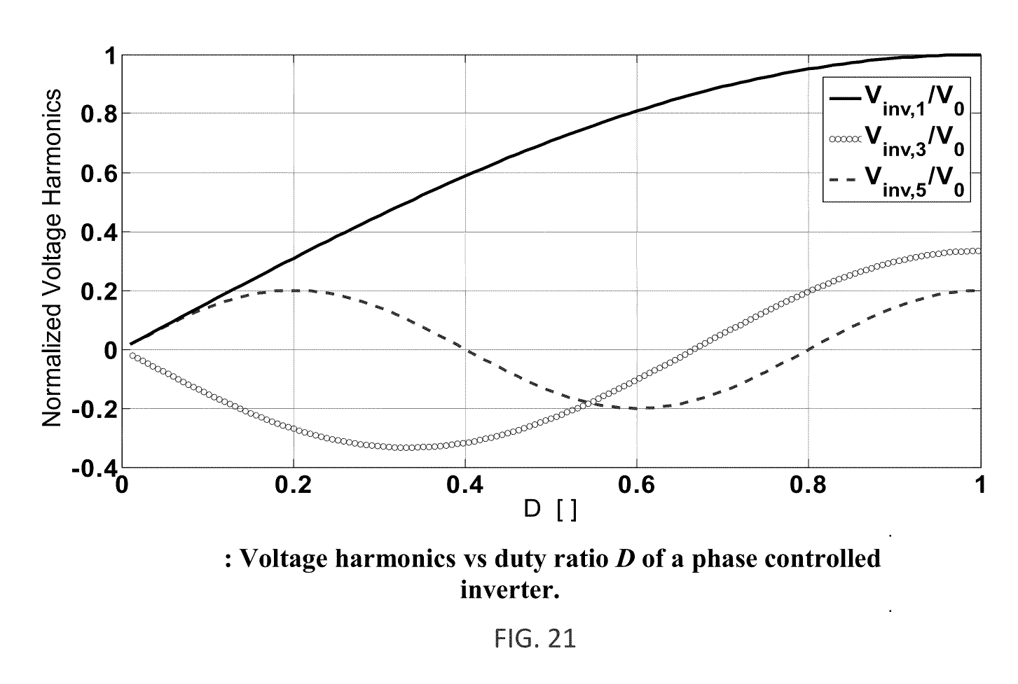

From (100) one can see that the voltage harmonics are in-phase or anti-phase and decreases with the harmonic order k. Let us analyze the influence of the duty ratio D to the fundamental and the next two harmonics. The normalized algebraic magnitude of the fundamental, the third and the fifth harmonics are shown in FIG. 21, where the normalization factor V₀=4V_{dc}/π has been used to provide an application-independent examination. As one can see, the duty ratio does not affect only the magnitude but also the phase of the harmonics. For example, the fundamental is always positive while the third harmonic becomes negative (changes its phase for 180°) when D gets lower than 2/3. For the future analysis it might be important to draw attention to two particular operational points: D=1 and D=1/3. When D=1, all harmonics are in phase and reach they maximum amplitudes. At D=1/3, the third harmonic is at its maximum, but shifted for 180° degrees, while the first harmonic is reduced by 50% referring to its maximum amplitude.

The exemplary circuit of a transmitter with that kind of the inverter's model is drawn in due to completeness of the presented material. The primary coil inductance is modeled by inductance Lₚ 2200, while the Z_{ref} 2202 represents the reflected secondary impedance at particular frequency. Resistive and reactive components of Z_{ref} 2202 are disclosed herein and quantified by (57)-(60) for n^{th} and k^{th} harmonics of the fundamental frequency f₁.

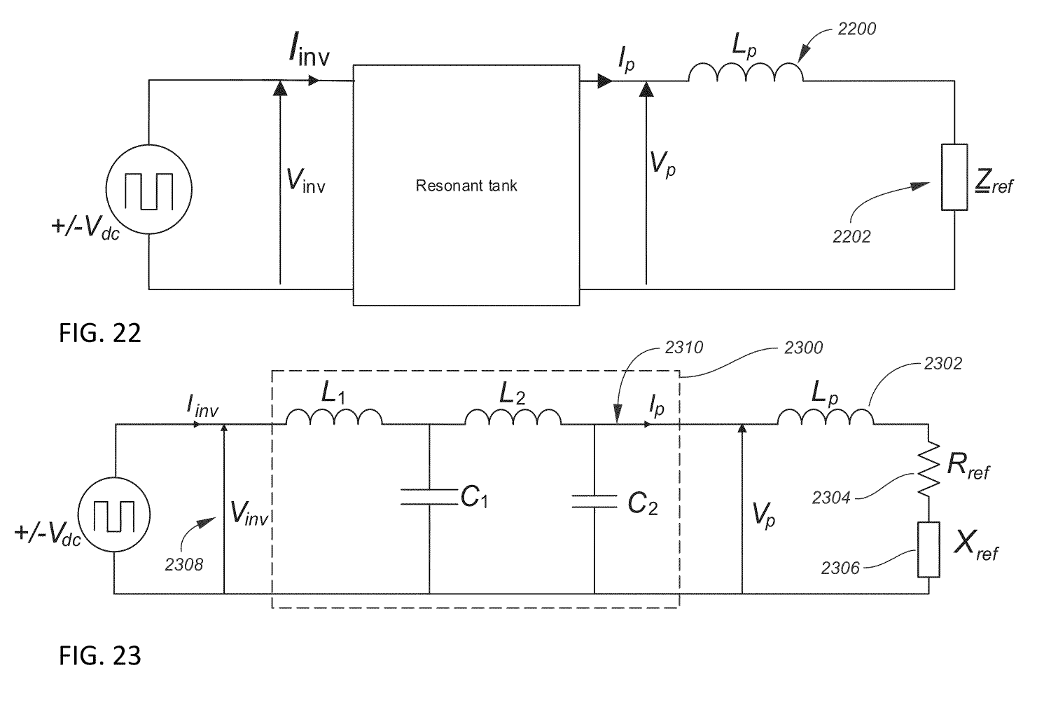

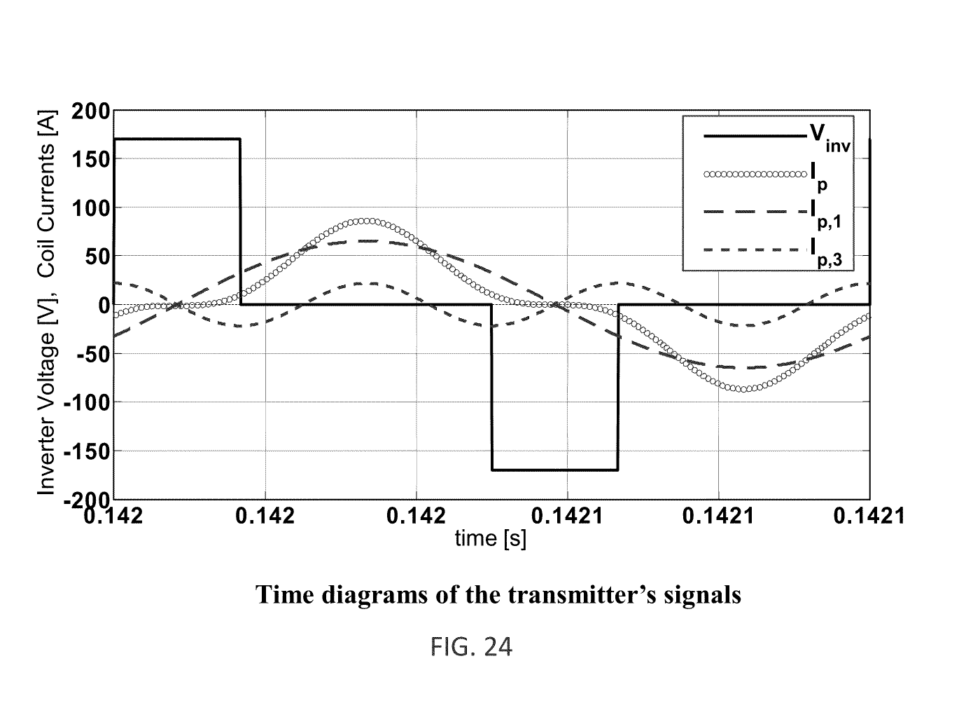

The resonant circuit in FIG. 22 resonates at two or more selected voltage harmonics, allowing multi-frequency current to supply the reflected load. Since the load may vary, a desirable feature of the system would be the load-independence of the primary coil current. It is similar feature to the one looked for with LCC compensation circuit, with the difference that now this independence should be extended to more than one resonant frequency. Therefore, next important step is to select the topology of the compensation circuit, which is suitable for the goals set. The number of used additional reactive components may be kept low (since it results in a compact and easy tunable design), but at the same time to have enough degrees of freedom for tuning. Let us narrow our design to bi-resonant system that exploits only two frequencies to transfer the power. Following the idea of the ladder Cauer's topology as disclosed herein, a similar L-C-L-C ladder is shown in. Compensation elements are represented by L₁-C₁-L₂-C₂ 2300, the primary coil inductance is denoted by Lₚ 2302, while R_{ref} 2304 and X_{ref} 2306 symbolize the resistance and the reactance reflected from the receiver side (receiver impedance referred to the primary).

Let us now derive the transconductance Gₚ that relates the input voltage Vᵢₙᵥ 2308 and current in the primary coil Iₚ 2310:

$${G}_{p , m} ( s ) = \frac{{I}_{p , m} ( s )}{{V}_{inv , m} ( s )} = \frac{1}{\begin{matrix}{s}^{5} {L}_{1} {L}_{2} {L}_{p , m}^{′} {C}_{2} {C}_{1} + {s}^{4} {R}_{ref , m} {L}_{2} {L}_{1} {C}_{2} {C}_{1} + \\ {s}^{3} [ ( {L}_{2} {C}_{1} + {L}_{p , m}^{′} {C}_{1} + {L}_{p , m}^{′} {C}_{2} ) {L}_{1} + {L}_{2} {L}_{p , m}^{′} {C}_{2} ] + \\ {s}^{2} {R}_{ref , m} [ {L}_{1} ( {C}_{1} + {C}_{2} ) + {L}_{2} {C}_{2} ] + s ( {L}_{1} + {L}_{2} + {L}_{p , m}^{′} ) + \\ {R}_{ref , m}\end{matrix}} m = n . k \qquad ( 101 )$$

where L′_{p,m} represents the modified inductance due to reflected reactance X_{ref,m}:

$$\begin{matrix}{L}_{p , m}^{′} = {L}_{p} + \frac{{X}_{ref , m}}{j m {ω}_{1}} & m = n . k\end{matrix} \qquad ( 102 )$$

After rearranging the expression in the denominator it becomes:

$${G}_{p , m} ( s ) = \frac{1}{\begin{matrix}( {sL}_{p , m}^{′} + {R}_{ref , m} ) ( {s}^{4} {L}_{1} {L}_{2} {C}_{2} {C}_{1} + {s}^{2} ( {C}_{1} {L}_{1} + {C}_{2} {L}_{1} + {L}_{2} {C}_{2} ) + 1 ) + \\ {s}^{3} {L}_{2} {C}_{1} {L}_{1} + s ( {L}_{1} + {L}_{2} )\end{matrix}} . \qquad ( 103 )$$

Evidently from (103), there is a way to make transconductance Gₚ load and primary-impedance independent, at resonant frequencies nω₁ and kω₁. Indeed, if the following conditions are satisfied:

$$\begin{matrix}\frac{{L}_{1} {C}_{2} + {L}_{1} {C}_{1} + {L}_{2} {C}_{2}}{{L}_{1} {L}_{2} {C}_{1} {C}_{2}} = {ω}_{1}^{2} ( \begin{matrix}{n}^{2} & {k}^{2} ) ,\end{matrix} & ( 104 ) \\ \frac{1}{{L}_{1} {L}_{2} {C}_{1} {C}_{2}} = {n}^{2} {k}^{2} {ω}_{1}^{4} . & ( 105 )\end{matrix}$$

The term s⁴L₁L₂C₁C₂+s⁴(L₁C₁+L₁C₂+L₂C₂)+1 becomes zero at both resonant frequencies nω₁ and kω₁. Consequently, the transconductance reduces to:

$${G}_{p} ( s ) = \frac{1}{{s}^{3} {L}_{2} {C}_{1} {L}_{1} + s ( {L}_{1} + {L}_{2} )} . \qquad ( 106 )$$

One can easily see that conditions (104)-(105) and expression for Gₚ(s) are identical to the expressions disclosed herein for receiver design. Since the design objectives for Gₚ are the same, (50)-(53) may be reused to calculate the parameters of compensation circuit. The expressions are rewritten here due to completeness:

$$\begin{matrix}{L}_{1} = \frac{1}{{ω}_{1}} \frac{1}{nk} \frac{( {k}^{2} - {n}^{2} )}{( {nG}_{p , k} - k {G}_{p , n} )} , & ( 107 ) \\ {L}_{2} = \frac{{( {nG}_{p , n} - k {G}_{p , k} )}^{2}}{{ω}_{1} ( {k}^{2} - {n}^{2} ) {G}_{p , k} {G}_{p , n} ( k {G}_{p , n} - {nG}_{p , k} )} , & ( 108 ) \\ {C}_{1} = \frac{1}{{ω}_{1}} \frac{1}{{k}^{2} - {n}^{2}} \frac{{( k {G}_{p , n} - {nG}_{p , k} )}^{2}}{( k {G}_{p , k} - {nG}_{p , n} )} , & ( 109 ) \\ {C}_{2} = \frac{( {k}^{2} - {n}^{2} ) {G}_{p , k} {G}_{p , n}}{{ω}_{1} nk ( {nG}_{p , n} - k {G}_{p , k} )} & ( 110 )\end{matrix}$$

where G_{p,n} and G_{p,k} represent the designed transconductance at nω₁ and kω₁. It should be noted by the reader that this approach makes the primary current load independent. Under the term “load” it is assumed not just the reflected resistance R_{ref} 2304, but also the reflected reactance X_{ref} 2306 as long as it is sufficiently small enough not to change the total inductive character of the coil impedance.

Another important discussion is related to the phases of transconductances. As it was already disclosed herein, selection of G_{p,n}<0 and G_{p,k}>0 would result in a feasible set of circuit values L₁-C₁-L₂-C₂. Taking into account the phase requirements of the receiver's coil open-circuit voltages (which essentially determines the operation of the receiver in Zone 1 or Zone 3) one can conclude that duty cycle ratio D of the input inverter cannot be picked-up arbitrarily.

Let us now elaborate the condition that the phase difference of the two engaged signals V_{inv,n} and V_{inv,k} (n<k) should satisfy to result in operation in the Zone 1 or Zone 3. On its path from the output of the inverter to the input of the rectifier the signal V_{inv,n}

is shifted in phase three times: by −90° through the primary resonant circuit, +90° due to Faraday's voltage induced in the receiving coil and −90° while it has been processed through the receiver's resonant tank. At the same time, the voltage harmonic V_{inv,k} is shifted three times by the same amount: +90°. Without losing the generality, it can be assumed that phase of V_{inv,n} at the output of the inverter is zero θ_{V,n,0}=0. Additionally, the whole phase shift of the signal V_{inv,n} can be taken from the input to the output of the system, scale by factor k/n and assign to V_{inv,k}. In that case the signal V_{inv,n} is unmoved and corresponding signal V_{ac,n} at the input of the rectifier contains zero phase (θ_{V,ac,n}=0), while the signal V_{inv,k} at the same place has the phase:

$${θ}_{Vac , k} = {θ}_{V , k , 0} + \frac{π}{2} + \frac{π}{2} + \frac{π}{2} - \frac{k}{n} ( - \frac{π}{2} + \frac{π}{2} - \frac{π}{2} ) = {θ}_{V , k , 0} + \frac{π}{2} ( 3 + \frac{k}{n} ) . \qquad ( 111 )$$

Obviously, if the system described herein is used to operate in Zone 1, the phase difference of the voltage signals at the input of the rectifier should be an integer number of the 2π [rad]:

$${θ}_{V , k , 0} + \frac{π}{2} ( 3 + \frac{k}{n} ) = i \cdot 2 π i = 0 , 1 , 2 , … , \qquad ( 112 )$$

while for the operation in Zone 3 the phase difference needs to be an odd number of π [rad]:

$${θ}_{V , k , 0} = \frac{π}{2} ( 3 + \frac{k}{n} ) = ( 2 i - 1 ) \cdot π i = 0 , 1 , 2 , … \qquad ( 113 )$$

From (112) and (113), the required initial phase θ_{V,k,0} that result in a system operating in the particular zone can be derived:

$$\begin{matrix}Zone 1 \text{:} {θ}_{V , k , 0} = i \cdot 2 π - \frac{π}{2} ( 3 + \frac{k}{n} ) i = 0 , 1 , 2 , … & ( 114 ) \\ Zone 3 \text{:} {θ}_{V , k , 0} = ( 2 i + 1 ) π \cdot \frac{π}{2} ( 3 + \frac{k}{n} ) i = 0 , 1 , 2 , … & ( 115 )\end{matrix}$$

As an example, this can be calculated for the harmonics n=3 and k=5, the phase of the V_{inv,k} for operation in Zone 1 and Zone 3 should be −π/3 and 2π/3, respectively.

Particularly interesting for practical applications is the case when the fundamental signal (n=1) is used. In that case (114) and (115) become simple:

$$\begin{matrix}Zone 1 ( n = 1 ) \text{:} {θ}_{V , k , 0} = 2 i \cdot π - \frac{π}{2} ( 3 + k ) i = 0 , 1 , 2 , … & ( 116 ) \\ Zone 3 ( n = 1 ) \text{:} {θ}_{V , k , 0} = ( 2 i + 1 ) π \cdot \frac{π}{2} ( 3 + k ) i = 0 , 1 , 2 , … & ( 117 )\end{matrix}$$

After an in-depth analysis, one can see that these expressions becomes even more simpler if the order of the second harmonic is divided into two categories: for k=3, 7, 11, . . . the required initial phases are:

Zone 1 (n=1, k=3,7,11, . . . ): θ_{V,k,0}=π (118)

Zone 3 (n=1, k=3,7,11, . . . ): θ_{V,k,0}=0 (119)

while for the other disjunctive category k=5, 9, 13, . . . the initial phases have exchanged values:

Zone 1 (n=1, k=5,9,13, . . . ): θ_{V,k,0}=0 (120)

Zone 3 (n=1, k=5,9,13, . . . ): θ_{V,k,0}=π (121)

Now it easy to see why the design with n=1 is particularly important: in that case the phase angles (118)-(121) are exactly the angles that can be obtained from a voltage pulse wave at the output of a full bridge phase-shift-controlled inverter. For instance, if the first and the third harmonics are engaged, they satisfy the condition for Zone 1 operation if 0<D<2/3 and conditions for Zone 3 operation if 1≧D>2/3. Inside these ranges the duty ratio D can be further used to adjust the harmonics magnitudes and regulate the power sharing among them. To determine the magnitudes of transconductances, the desired amounts of transferred power have to be considered:

Pₘ=(V_{inv,m}G_{p,m})²R_{ref,m} m=n,k (122)

From (122), the magnitudes of the transconductance can be calculated as:

$${G}_{p , m} = \frac{1}{{V}_{inv , m}} \sqrt{\frac{{P}_{m}}{{R}_{ref , m}}} m = n , k , \qquad ( 123 )$$

where V_{inv,m} depends on duty ratio D and is defined by:

$${V}_{inv , m} = \frac{4 {V}_{dc}}{π} \frac{sin ( \frac{m π D}{2} ) sin ( \frac{m π}{2} )}{m} m = n , k . \qquad ( 124 )$$

The exemplary design of the 500 W, 10 kHz IPT multi-resonant system as disclosed herein, now shows the design of the power transmitter side. As disclosed herein, the exemplary goal is to transfer 500 W of power by using the first and the third harmonics (n=1, k=3) of a f₁=10 kHz system. For this example, it is assumed that the primary and secondary inductances are identical (Lₚ=L₁=34.76 μH) and that the coupling coefficient is k_{c}=0.1. The high frequency full bridge inverter is supplied from a dc link that generates a stable voltage: V_{dc}=169.7 V. All inverter switches and elements of the resonant circuit are assumed ideal (lossless).

### Step 1: Calculation of the Reflected Resistances and Reactances R_{ref,1} R_{ref,3}, X_{ref,1} and X_{ref,3};

By applying (57)-(60), values for reflected resistances and reactances at resonant frequencies 10 kHz and 30 kHz can be obtained:

R_{ref,1}=0.1192 (125)

X_{ref,1}=0.0112Ω, (126)

R_{ref,3}=1.0732, (127)

X_{ref,3}=0.1525Ω. (128)

### Step 2:Calculation of the Transconductances G_{p,1}<0 and G_{p,3}>0;

Considering the fact that the first and third harmonic are used and that the receiver has been already designed to operate in Zone 1, a suitable duty ratio value should be selected. As described herein, this operational conditions requires D from the range (0, 2/3). Let us assume that value D=1/3 is chosen, since it generates the maximum amplitude of the third harmonic. Consequently, the rms values of the voltage harmonics may be:

$$\begin{matrix}{V}_{inv , 1} = \frac{2 \sqrt{2} {V}_{dc}}{π} sin ( \frac{π D}{2} ) = 76.39 V ( rms ) , & ( 129 ) \\ {V}_{inv , 3} = \frac{2 \sqrt{2} {V}_{dc}}{3 π} sin ( \frac{3 π D}{2} ) = 50.93 V ( rms ) . & ( 130 )\end{matrix}$$

In order to deliver specified amount of power, the primary coil currents have to be:

$$\begin{matrix}{I}_{p , 1} = \sqrt{\frac{{P}_{1}}{{R}_{ref , 1}}} = 45.79 A , & ( 131 ) \\ {I}_{p , 3} = \sqrt{\frac{{P}_{3}}{{R}_{ref , 3}}} = 15.26 A . & ( 132 )\end{matrix}$$

Consequently, the values of the transconductances are:

$$\begin{matrix}- {G}_{p , 1} = - \frac{{I}_{p , 1}}{{V}_{inv , 1}} = 0.6 S , & ( 133 ) \\ {G}_{p , 3} = \frac{{I}_{p , 3}}{{V}_{inv , 3}} = 0.3 S . & ( 134 )\end{matrix}$$

### Step 3: Design of the Resonant Circuit L₁, L₂, C₁ and C₂;

After the transconductances are substituted in (107)-(110), the compensation elements are obtained as:

L₁=20.23 μH

L₂=11.85 μH

C₁=5.84 μF

C₂=5.09 μF (135)

As the simplest way to validate the analytical derivations presented, an exemplary Simulink model has been built and this particular operational condition is simulated. The result of the expected analytical values and corresponding values extracted from the simulation results are comparatively shown in the Table 4. Again, excellent matching between them can be used as an indirect proof of the presented methodical approach. Finally, inverter's output voltage Vᵢₙᵥ, primary coil current Iₚ and its two harmonic components I_{p.1} and I_{p,3} are extracted from the simulation results and shown in. As one can see, the error between the simulated and analytically derived values are slightly greater when the whole system is simulated, mainly due to the approximate formula used to calculate the impedances reflected from the secondary to the primary circuit.

TABLE 4
Transmitter - a comparative presentation of the
analytical and simulation results

| When an RLC block is used to | | | When the whole system | | |
|---|---|---|---|---|---|
| model the transferred impedance | | | (transmitter + receiver) is modeled | | |
| Parameter | Analysis | Simulation | Parameter | Analysis | Simulation |
| I_{p,1} [A] | 45.79 | 45.79 | I_{p,1} [A] | 45.79 | 45.96 |
| I_{p,3} [A] | 15.26 | 15.24 | I_{p,3} [A] | 15.26 | 15.26 |
| P_{ac,1} [W] | 250 | 250 | P_{ac,1} [W] | 250 | 251.4 |
| P_{ac,3} [W] | 250 | 249.25 | P_{ac,3} [W] | 250 | 250.7 |

While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A power transfer system comprising:
a receiver configured to wirelessly receive power for powering an electronic device;
a power source; and
at least one transmitter operably coupled to the power source for wireless transfer of power generated by the power source, wherein when the at least one transmitter is operably coupled to the receiver, the power source and the at least one transmitter operate together in a first mode such that the power source generates power at a first level and the at least one transmitter transfers the generated power to the receiver, and
wherein when the at least one transmitter is not operably coupled to the receiver, the power source and the at least one transmitter operate together in a second mode such that the power source generates power at a second level lower than the first level or equal to zero and the transmitter does not wirelessly transfer power.

2. The power transfer system of claim 1, wherein the at least one transmitter is configured to simultaneously transfer power to the receiver on a plurality of frequencies.

3. The power transfer system of claim 1, wherein the power source comprises an inverter.

4. The power transfer system of claim 1, wherein the receiver has a receiver input impedance, and wherein the at least one transmitter has a transmitter reflected impedance.

5. The power transfer system of claim 4, wherein the at least one transmitter is configured such that the transmitter reflected impedance is substantially a reflected voltage from the receiver divided by the current from the power source.

6. The power transfer system of claim 1, wherein the receiver is an inductance-capacitance-capacitance (LCC) receiver, the LCC receiver has a first capacitance, a second capacitance and an inductance, wherein the LCC receiver has a quality factor defined as:
$${Q}_{total} = ( \frac{{C}_{2}}{{C}_{1}} + 1 ) \cdot ( \frac{{C}_{2}}{{C}_{1}} + 1 ) \cdot \frac{{R}_{eq}}{ω {L}_{2}}$$
where R_{eq} is defined as
$$\frac{{π}^{2}}{8} {R}_{Load}$$
due to the action of a rectifier;
ω is the resonant frequency of the LCC receiver;
C₁ is the first capacitance;
C₂ is the second capacitance;
L₂ is the inductance.

7. The power transfer system of claim 6, wherein the first capacitor and the second capacitor form a resonant tank.

8. The power transfer system of claim 1, wherein the at least one transmitter comprises a plurality of transmitters.

9. The power transfer system of claim 1, wherein the power source is configured to generate an alternating current.

10. The power transfer system of claim 1, wherein the power source is connected to an electrical grid.

11. The power transfer system of claim 1, wherein the power source a compensation tank configured to control the phase between the voltage and the current generated by the power source and the voltage and current at the receiver.

12. The power transfer system of claim 1, wherein the receiver comprises a compensation tank configured to extract maximum power.

13. The power transfer system of claim 1, wherein the power source is a multi-frequency source configured to emit power at multiple frequencies.

14. A method comprising:
providing at least one transmitter operably coupled to a power source for wireless transfer of power generated by the power source to a receiver; and
when the at least one transmitter is operably coupled to the receiver:
operating the power source and the at least one transmitter together in a first mode such that the power source generates power at a first level and the at least one transmitter transfers the generated power to the receiver;
when the at least one transmitter is not operably coupled to the receiver, operating the power source and the at least one transmitter operate together in a second mode such that the power source to generate power at a second level lower than the first level or equal to zero and the transmitter does not wirelessly transfer power.

15. The method of claim 14, wherein operating the power source and the at least one transmitter together comprises operating the at least one transmitter to simultaneously transmit power to the receiver on a plurality of frequencies.

16. The method of claim 14, wherein the power source comprises an inverter.

17. The method of claim 14, wherein the receiver has a receiver input impedance, and wherein the at least one transmitter has a transmitter reflected impedance.

18. The method of claim 17, wherein the at least one transmitter is configured such that the transmitting reflected impedance is substantially a reflected voltage from the receiver divided by the current from the power source.

19. The method of claim 17, wherein the receiver is an inductance-capacitance-capacitance (LCC) receiver, the LCC receiver having a first capacitance, a second capacitance and an inductance, wherein the LCC receiver has a quality factor defined as:
$${Q}_{total} = ( \frac{{C}_{2}}{{C}_{1}} + 1 ) \cdot ( \frac{{C}_{2}}{{C}_{1}} + 1 ) \cdot \frac{{R}_{eq}}{ω {L}_{2}}$$
where R_{eq} is defined as
$$\frac{{π}^{2}}{8} {R}_{Load} ;$$
ω is the resonant frequency of the LCC receiver;
C₁ is the first capacitance;
C₂ is the second capacitance;
L₂ is the inductance.

20. The method of claim 19, wherein the first capacitor and the second capacitor of the receiver form a resonant tank.

21. The method of claim 14, wherein the at least one transmitter comprises a plurality of transmitters.

22. The method of claim 14, wherein the power source is configured to provide an alternating current.

23. The method of claim 14, wherein the power source is connected to an electrical grid.

24. A receiver in closely-spaced apart arrangement relative to a power source and configured to be operably coupled with an electronic device.

25. The receiver of claim 24, wherein the receiver is configured to receive power on a plurality of frequencies simultaneously.

26. The receiver of claim 24, wherein the receiver has a receiver input impedance.

27. The receiver of claim 24, wherein the receiver is an inductance-capacitance-capacitance (LCC) receiver, the LCC receiver having a first capacitance, a second capacitance and an inductance, wherein the LCC receiver has a quality factor defined as:
$${Q}_{total} = ( \frac{{C}_{2}}{{C}_{1}} + 1 ) \cdot ( \frac{{C}_{2}}{{C}_{1}} + 1 ) \cdot \frac{{R}_{eq}}{ω {L}_{2}}$$
where R_{eq} is defined as
$$\frac{{π}^{2}}{8} {R}_{Load} ;$$
ω is the resonant frequency of the LCC receiver;
C₁ is the first capacitance;
C₂ is the second capacitance;
L₂ is the inductance.

28. The receiver of claim 27, wherein the first capacitor and the second capacitor form a resonant tank.

29. A transmitter configured to be one of coupled and uncoupled to a power source and a receiver, the at least one transmitter being configured such that the current through the power source increases when the at least one transmitter is coupled between the power source and the receiver for transferring power to the receiver, and such that the current decreases when the at least one transmitter is not coupled between the power source and the receiver.

30. The transmitter of claim 29, wherein the at least one transmitter is configured to transfer power to the receiver on a plurality of frequencies simultaneously.

31. The transmitter of claim 29, wherein the transmitter has a transmitter reflected impedance.

32. The transmitter of claim 31, wherein the transmitter is configured such that the transmitter reflected impedance is substantially a reflected voltage from the receiver divided by the current from the power source.

33. The transmitter of claim 29, wherein the transmitter is configured to transfer power using an alternating current.
